(19) United States
(12) Patent Application Publication
(10) Pub. No.: US 2026/0300760 A1
(43) Pub. Date: Oct. 1, 2026

(54) GRAPH-BASED MODELS WITH LATCH NODES

(71) Applicant: Infosys Limited, Bangalore (IN)

(72) Inventor: Steven SCHILDERS, Columbus, IN (US)

(73) Assignees: Infosys Limited, Bangalore (IN); InvertIT Inc, Columbus, IN (US)

(21) Appl. No.: 19/094,877

(22) Filed: Mar. 29, 2025

(30) Foreign Application Priority Data
Mar. 28, 2025 (IN) 202541030221

(51) Int. Cl. G06N 5/02

(52) U.S. Cl. CPC G06N 5/02

(57) ABSTRACT

An overlay system is provided that includes a storage element and processing circuitry coupled thereto. The storage element stores an executable graph-based model that includes a plurality of active nodes and a plurality of latch nodes. The processing circuitry detects state changes in a first active node of the plurality of active nodes based on a first latch node of the plurality of latch nodes. The first latch node couples the first active node and a second active node of the plurality of active nodes. Further, the state changes detected in the first active node are to be transferred to the second active node. The processing circuitry receives a reset signal indicating an availability of the second active node to receive the first set of state changes. Additionally, the processing circuitry transfers the set of state changes to the second active node based on the reception of the reset signal.

### FIELD OF THE DISCLOSURE

Various embodiments of the present disclosure relate generally to graph-based models. More specifically, various embodiments of the present disclosure relate to executable graph-based models with latch nodes.

### BACKGROUND

With the rapid development of computing, graph-based models have become essential in numerous areas, leading to implementation in numerous applications (such as social networks, knowledge graphs, network analysis, natural language processing, or the like) that utilize the graph-based models. A technology that is implemented by way of a graph-based model has each unit associated therewith realized as a node of the graph-based model. Such use of the graph-based model enables complete control over even the smallest unit of the technology. Each node in the graph-based model is connected to one or more other nodes in the graph-based model. Further, a state change in a node is transferred immediately to the connected one or more nodes. Such immediate transfer of state change is not desirable in various applications.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating latch nodes in executable graph-based models are provided substantially as shown in, and described in connection with, at least one of the figures.

Certain embodiments of the disclosure may disclose an overlay system. The overlay system comprises a storage element and processing circuitry that is coupled to the storage element. The storage element is configured to store an executable graph-based model that includes a plurality of active nodes and a plurality of latch nodes, with each latch node coupling at least two active nodes. The processing circuitry is configured to detect, based on a first latch node of the plurality of latch nodes, a first set of state changes in a first active node of the plurality of active nodes. The first latch node couples the first active node and a second active node of the plurality of active nodes. Further, the first set of state changes detected in the first active node is to be transferred to the second active node. The processing circuitry is further configured to receive a reset signal associated with the first latch node, the reset signal indicating an availability of the second active node to receive the first set of state changes. Further, the processing circuitry is configured to transfer the first set of state changes to the second active node based on the reception of the reset signal.

In some embodiments, the processing circuitry is further configured to receive a first stimulus associated with the overlay system, and identify, based on the first stimulus, the first active node. Further, the processing circuitry is configured to execute an operation associated with the first stimulus based on the first active node. The execution of the operation associated with the first stimulus results in the first set of state changes in the first active node.

In some embodiments, the executable graph-based model further includes a plurality of overlay nodes. The processing circuitry is further configured to identify, from the plurality of overlay nodes, a first set of overlay nodes that is associated with the first active node. The first set of overlay nodes is configured to extend functionality of the first active node. Additionally, the operation associated with the first stimulus is executed further based on the first set of overlay nodes.

In some embodiments, the first latch node has a plurality of latch roles associated therewith. Further, an input latch role of the plurality of latch roles couples the first latch node to the first active node, and an output latch role of the plurality of latch roles couples the first latch node to the second active node

In some embodiments, the processing circuitry transfers the first set of state changes from the first active node to the second active node using the input latch role and the output latch role.

In some embodiments, the plurality of latch roles includes a trigger latch role, where the first latch node is coupled to the first active node by way of the trigger latch role. The processing circuitry is further configured to monitor, using the trigger latch role, the first active node. Further, the processing circuitry detects the first set of state changes based on the monitoring of the first active node using the trigger latch role.

In some embodiments, the processing circuitry is further configured to generate, using the trigger latch role, a trigger signal based on the detection of the first set of state changes. The transfer of the first set of state changes is further based on the trigger signal.

In some embodiments, the trigger signal is one of a group consisting of a data signal, a timing signal, or a clock signal.

In some embodiments, the processing circuitry transfers the first set of state changes to the second active node based on a signal potential of the trigger signal being greater than a potential threshold.

In some embodiments, the trigger signal is one of a group consisting of an excitation signal or an inhibition signal. Further, the excitation signal is a positive signal and the inhibition signal is a negative signal.

In some embodiments, the plurality of latch roles includes a reset latch role, where the first latch node is coupled to the second active node by way of the reset latch role. The processing circuitry is further configured to monitor, using the reset latch role, the second active node. Additionally, the processing circuitry receives the reset signal based on the monitoring of the second active node using the reset latch role.

In some embodiments, the processing circuitry is further configured to receive a second stimulus associated with the overlay system, and identify, based on the second stimulus, the second active node. Further, the processing circuitry is configured to execute an operation associated with the second stimulus based on the second active node. The reset signal is received based on the execution of the operation associated with the second stimulus.

In some embodiments, the reset latch role is coupled to the second active node by way of a third active node of the plurality of active nodes. The processing circuitry monitors the second active node further based on the third active node.

In some embodiments, the processing circuitry is further configured to receive an enable signal associated with the first latch node. The transfer of the first set of state changes is further based on the enable signal.

In some embodiments, the processing circuitry is further configured to receive a third stimulus associated with the overlay system, where the third stimulus is received after the transfer of the first set of state changes to the second active node. Further, the processing circuitry is configured to identify, based on the third stimulus, the second active node. Additionally, the processing circuitry is configured to execute an operation associated with the third stimulus based on the second active node with the first set of state changes.

In some embodiments, the executable graph-based model further includes a plurality of overlay nodes. The processing circuitry is further configured to identify, from the plurality of overlay nodes, a second set of overlay nodes that is associated with the second active node. The second set of overlay nodes is configured to extend functionality of the second active node. Additionally, the operation associated with the third stimulus is executed further based on the second set of overlay nodes.

In some embodiments, the processing circuitry is further configured to detect a second set of state changes in a fourth active node of the plurality of active nodes based on a second latch node of the plurality of latch nodes. The second latch node couples the fourth active node and a fifth active node of the plurality of active nodes. Further, the second set of state changes detected in the fourth active node is to be transferred to the fifth active node. The processing circuitry is further configured to transfer the second set of state changes to the fifth active node based on the reception of the reset signal, where the reset signal further indicates an availability of the fifth active node to receive the second set of state changes. Further, the first set of state changes and the second set of state changes are synchronously transferred to the second active node and the fifth active node, respectively, based on the reset signal.

In some embodiments, the executable graph-based model further includes a plurality of overlay nodes. The processing circuitry is further configured to identify, from the plurality of overlay nodes, a third set of overlay nodes that is associated with the first latch node. The third set of overlay nodes is configured to extend functionality of the first latch node. The processing circuitry is further configured to execute the third set of overlay nodes on the first latch node based on the reception of the reset signal. The first set of state changes is modified based on the execution of the third set of overlay nodes to obtain a modified first set of state changes. Further, the transfer of the first set of state changes corresponds to a transfer of the modified first set of state changes.

In some embodiments, the processing circuitry is further configured to detect, based on the first latch node, a third set of state changes in the first active node. The first latch node further couples the first active node and a sixth active node of the plurality of active nodes. Additionally, the third set of state changes detected in the first active node is to be transferred to the sixth active node. The processing circuitry is further configured to transfer the third set of state changes to the sixth active node based on the reception of the reset signal. The reset signal is further indicative of an availability of the sixth active node to receive the third set of state changes.

In some embodiments, each state change in the first set of state changes corresponds to a change in a node element of the first active node.

In some embodiments, the first set of state changes is periodic.

In some embodiments, each node of the plurality of active nodes is one of a group consisting of a vertex node, an edge node, a role node, an overlay node, an attribute vertex node, or an attribute edge node.

In some embodiments, each active node of the plurality of active nodes and each latch node of the plurality of latch nodes is a run-time node that includes a node template and a node instance, where the node template corresponds to a predefined node structure, whereas the node instance corresponds to an implementation of the node template.

In certain additional embodiments, a method is disclosed. The method comprises detecting, by processing circuitry of an overlay system, based on a first latch node of a plurality of latch nodes, a first set of state changes in a first active node of a plurality of active nodes. An executable graph-based model is stored in a storage element of the overlay system and the executable graph-based model includes the plurality of active nodes and the plurality of latch nodes, with each latch node coupling at least two active nodes. Further, the first latch node couples the first active node and a second active node of the plurality of active nodes. Additionally, the first set of state changes detected in the first active node is to be transferred to the second active node. The method further includes receiving, by the processing circuitry, a reset signal associated with the first latch node, the reset signal indicating an availability of the second active node to receive the first set of state changes. The method further includes transferring, by the processing circuitry, the first set of state changes to the second active node based on the reception of the reset signal.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, consistent with disclosed embodiments of the present disclosure;

FIG. 2 is a block diagram that illustrates a system environment of an overlay system for execution, management, and configuration of the executable graph-based model, consistent with disclosed embodiments of the present disclosure;

FIG. 3 is a block diagram that illustrates a generic structure of an active node within the executable graph-based model, consistent with disclosed embodiments of the present disclosure;

FIG. 4 is a block diagram that illustrates a generic structure of a latch node within the executable graph-based model, consistent with disclosed embodiments of the present disclosure;

FIG. 5 is a block diagram that illustrates a generic structure of a run-time node within the executable graph-based model, consistent with disclosed embodiments of the present disclosure;

FIG. 6 is a block diagram that illustrates an executable node within the executable graph-based model, consistent with disclosed embodiments of the present disclosure;

FIG. 7 is a block diagram that illustrates a composition of the executable node that enables persistent storage of data and processing logic associated therewith, consistent with disclosed embodiments of the present disclosure;

FIGS. 8A-8C, collectively, illustrate features of latch nodes in the executable graph-based model, consistent with disclosed embodiments of the present disclosure;

FIG. 9 is a schematic diagram that illustrates an implementation of latch nodes in an executable graph-based model, consistent with disclosed embodiments of the present disclosure;

FIG. 10 shows an example computing system for carrying out methods of the present disclosure, consistent with disclosed embodiments of the present disclosure; and

FIGS. 11A and 11B, collectively, illustrate a flowchart of a method for processing a stimulus using a latch node, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Conventionally, in graph-based models, a state change in a node is immediately transferred to one or more connected nodes in the graph-based models. In numerous applications, the immediate transfer of state change to one or more connected nodes is not desirable. For example, in neural networks, a correlation between inputs and corresponding output is crucial. However, state changes in one or more nodes connected to input nodes of the neural network result in immediate state changes in the input nodes while hidden layer nodes of the neural network are still processing based on previous states of the input nodes. Further, output nodes of the neural network generate the output based on the processing of the hidden layer nodes. Thus, when the output is generated, the state of input nodes for which the output is generated is changed. Therefore, a correlation between the inputs and the output is lost due to the immediate transfer of the state changes.

The present disclosure is directed to the facilitation of latch nodes in an executable graph-based model of an overlay system. The executable graph-based models are customized hypergraphs having hyper-edges and vertices that are realized by way of nodes. Each node is associated with a particular node-type. For example, an edge node corresponds to a node with an edge node-type. Nodes are connected with other nodes by way of edge nodes (e.g., roles included in the edge nodes). In some embodiments, roles are represented by way of nodes of role node-type. A role node between two nodes may be indicative of details regarding an association therebetween. The executable graph-based model also includes a plurality of overlay nodes that incorporate in-situ features in the overlay system. Each overlay node is associated with one or more nodes (for example, a vertex node, an edge node, or the like) of the executable graph-based model and includes a processing logic that when executed implements a functionality thereof on the associated nodes. Hence, the processing logic is implemented within the executable graph-based model and is not required to be retrieved from any external system.

In an example, the overlay system includes an executable graph-based model that includes various active nodes (for example, vertex nodes, edge nodes, or the like) and various latch nodes, where each latch node couples two or more active nodes. A latch node facilitates a transfer of state changes from one active node to another active node based on various conditions. The latch node has latch roles associated therewith. The latch roles include an input latch role, a trigger latch role, a reset latch role, and an output latch role. The input latch role and the trigger latch role couples the latch node to the active node from which the state changes are to be transferred from. Further, the reset latch role and the output latch role couples the latch node to the active node to which the state changes are to be transferred to. In operation, processing circuity of the overlay system may detect state changes in the active node using the trigger latch node. The detected state changes are to be transferred to the other active node coupled to the latch node. Further, the processing circuitry may receive a reset signal associated with the latch node by using the reset latch role. The reset signal indicates an availability of the other active node to receive the detected state changes. Thus, the processing circuitry transfers the detected state changes to the other active node based on the reception of the reset signal. The detected state changes are transferred using the input latch role and the output latch role.

Conventionally, in the graph-based models, state changes in one node cause immediate state changes in one or more connected nodes, without considering availability of the one or more connected nodes to receive the state changes. In contrast, the present invention discloses latch nodes in the executable graph-based model that may ensure that the state changes are transferred to the connected nodes only when the connected nodes may be available to receive the state changes.

Notably, the present disclosure allows for the latch nodes within the executable graph-based model of the overlay system. Each latch node couples two or more active nodes in the executable graph-based model. Further, the latch node may facilitate the transfer of state changes from one active node to another active node only when the other active node is available to receive the state changes. Thus, in various applications such as neural networks, a correlation between inputs and a corresponding output may be obtained as states of the input nodes are changed after completion of processing based on current state of input nodes and generation of output based on the current state of the input nodes.

It is appreciated that the human mind is not equipped to detect state changes in the active node based on the latch node from a high volume of active nodes and latch nodes present in the overlay system, receive the reset signal, and transfer the detected state changes to the other active node that is coupled to the latch node based on the reception of the reset signal. It is appreciated that the approaches discussed herein improve the technical field of computer performance by reducing time complexity.

### Figure Description

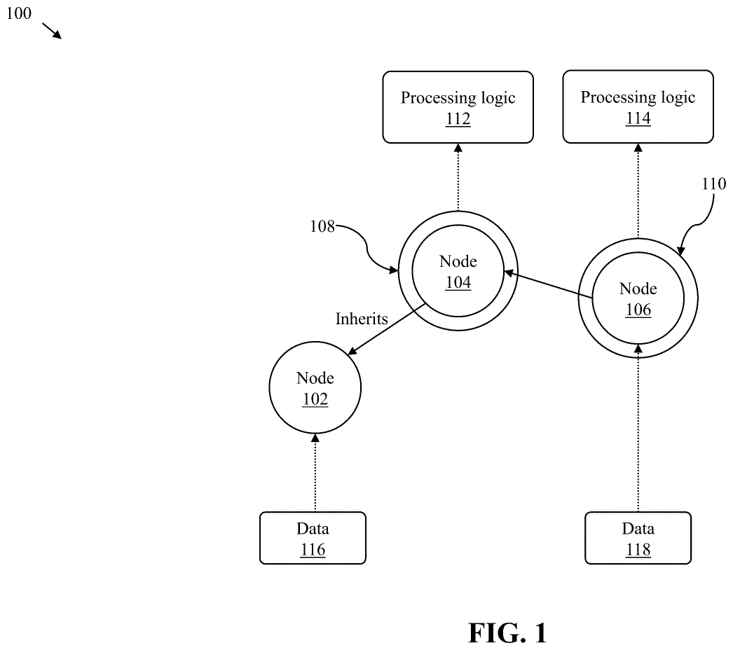

FIG. 1 is a graph that illustrates a composition of an executable graph-based model 100, consistent with disclosed embodiments of the present disclosure. Referring to FIG. 1, the executable graph-based model 100 is generally formed of a data structure (e.g., a graph-based model or a graphical model) comprising a plurality of nodes 102-106 which can be functionally extended with processing logic via use of overlays. For example, as shown in FIG. 1, the nodes 104 and 106 are functionally extended with processing logic via the use of overlay nodes 108 and 110, respectively. Although not shown, the node 102 can be similarly extended with processing logic via the use of one or more overlays. Each overlay includes processing logic, such as processing logic 112 and 114 which are associated with the overlay nodes 108 and 110, respectively. At run-time, data, such as data 116 and 118, is associated with the nodes 102 and 106, respectively. Further, the overlay nodes 108 and 110 of the nodes 104 and 106, respectively, provide the functionality to respond to stimuli and interact with, manipulate, or otherwise process the data based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

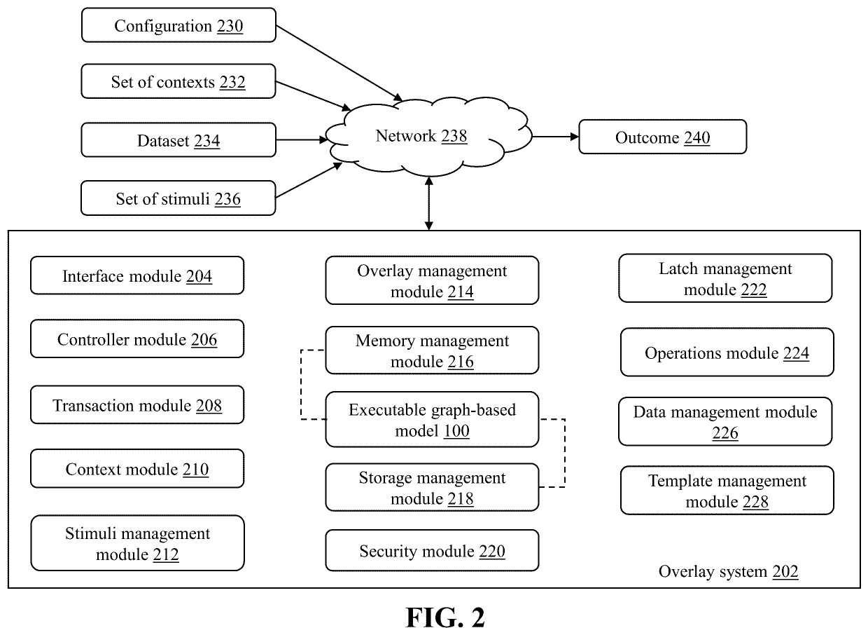

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes are extended to include overlays in order to form the executable graph-based model 100. As such, the executable graph-based model 100 includes one or more nodes that can be dynamically generated, extended, or processed by one or more other modules within an overlay system (shown in FIG. 2). Throughout the description, the terms “overlay node” and “overlay” are used interchangeably.

Notably, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 applies to a range of time-critical systems where efficient processing of the stimuli is required.

FIG. 2 is a block diagram that illustrates a system environment 200 of an overlay system 202 for execution, management, and configuration of the executable graph-based model 100, consistent with disclosed embodiments of the present disclosure. Referring to FIG. 2, the overlay system 202 includes the executable graph-based model 100. The overlay system 202 further includes an interface module 204, a controller module 206, a transaction module 208, a context module 210, a stimuli management module 212, an overlay management module 214, a memory management module 216, a storage management module 218, a security module 220, a latch management module 222, an operations module 224, a data management module 226, and a template management module 228. FIG. 2 further shows a configuration 230, a set of contexts 232, dataset 234, a set of stimuli 236, a network 238, and an outcome 240. In some embodiments, all the modules of the overlay system 202 except for the executable graph-based model 100 may collectively form processing circuitry that facilitate operations associated with a plurality of active nodes and a plurality of latch nodes in the executable graph-based model 100. An active node may refer to a node, in the executable graph-based model 100, with an edge node-type, a role node-type, a vertex node-type, or an overlay node-type. An active node with the vertex node-type is coupled to another active node with the vertex node-type by way of a node with the edge node-type indicative of a role of the active node. A latch node refers to a node with a latch node-type. A latch node couples one or more active nodes and facilitates a transfer of state changes from one active node to one or more active nodes.

The overlay system 202 may include suitable logic, circuitry, interfaces, and/or code, executable by the circuitry, that may be configured to facilitate one or more operations associated with the latch nodes in the executable graph-based model 100.

The interface module 204 may include suitable logic, circuitry, interfaces, and/or code, executable by the circuitry, configured to provide a common interface between internal modules of the overlay system 202 and/or external sources. The interface module 204 provides an application programmable interface (API), scripting interface, or any other suitable mechanism for interfacing externally or internally with any module of the overlay system 202. The configuration 230, the set of contexts 232, the dataset 234, and the set of stimuli 236 may be received by the interface module 204 via the network 238. Similarly, outputs (e.g., the outcome 240) produced by the overlay system 202 are passed by the interface module 204 to the network 238 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 2, the interface module 204 may be communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the set of stimuli 236) and their associated contexts (such as the set of contexts 232) provide the basis for all interactions within the executable graph-based model 100. Processing of such stimuli may lead to execution of processing logic associated with one or more overlays within the executable graph-based model 100. The processing of the stimuli within the overlay system 202 may be referred to as a system transaction. The processing and execution of stimuli (and associated overlay execution) within the overlay system 202 is handled by the controller module 206. The controller module 206 manages all received input stimuli (e.g., the set of stimuli 236) and processes them based on a corresponding context (e.g., one of the set of contexts 232). The context of the set of contexts 232 determines the priority that is to be assigned to the processing of the corresponding stimulus by the controller module 206 or the context module 210. This allows each stimulus to be configured with a level of importance and prioritization within the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. Maintaining system integrity via the controller module 206 and the transaction module 208 allows a transaction to be rolled back in an event of an expected or unexpected software or hardware fault or failure. The controller module 206 is configured to handle the processing of the set of stimuli 236 and transactions through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture, whereby the set of stimuli 236 within the overlay system 202 is associated with the set of contexts 232 which is used to adapt the handling or processing of the set of stimuli 236 by the overlay system 202. That is to say that the handling or processing of the set of stimuli 236 is done based on the set of contexts 232 associated therewith. Hence, each stimulus of the set of stimuli 236 is a contextualized stimulus. Further, each context of the set of contexts 232 may include details such as username, password, access token, device information, time stamp, one or more relevant identifiers (IDs), or the like, that are required for processing of the corresponding stimulus of the set of stimuli 236 within the executable graph-based model 100. Each context within the overlay system 202 may be extended to include additional information that is required for the processing of the stimulus (e.g., a query, a command, or an event).

The context module 210 may include suitable logic, circuitry, interfaces, and/or code, executable by the circuitry, configured to manage the handling of contexts within the overlay system 202. The context module 210 is responsible for processing any received contexts (e.g., the set of contexts 232) and translating the received context to an operation execution context. In some examples, the operation execution context is larger than the received context because the context module 210 supplements the received context with further information necessary for the processing of the received context. The context module 210 passes the operation execution context to one or more other modules within the overlay system 202 to drive communication of data associated with the operation execution context. Contexts within the overlay system 202 may be external or internal. While some contexts apply to all application areas and problem spaces, some applications may require specific contexts to be generated and used to process the received set of stimuli 236. As will be described in more detail below, the executable graph-based model 100 is configurable (e.g., via the configuration 230) so as only to execute within a given execution context for a given stimulus.

The stimuli management module 212 may include suitable logic, circuitry, interfaces, and/or code, executable by the circuitry, configured to process externally received stimuli (e.g., the set of stimuli 236) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IoT) device. As previously stated, a stimulus (such as a stimulus of the set of stimuli 236) may be either externally or internally generated. In an example, a stimulus of the set of stimuli 236 may be a message that is internally triggered (e.g., generated) from any of the modules within the overlay system 202. Such internal generation of the stimulus indicates that something has happened within the overlay system 202 and subsequent handling by one or more other modules within the overlay system 202 may be required. Internal stimulus may also be triggered (e.g., generated) from the execution of processing logic associated with overlays within the executable graph-based model 100. In another example, a stimulus of the set of stimuli 236 may be externally triggered and may be generated based on an input received via a user interface associated with the controller module 206. The externally triggered stimulus may be received in the form of a signal, a textual, audio, or visual input. The externally triggered stimulus may be associated with the intent of a user to execute an operation indicated by the stimulus. The operation is executed in accordance with information included in the context associated with the stimulus.

The stimuli management module 212 may receive the stimuli (such as the set of stimuli 236) in real-time or near-real-time and communicate the received stimuli to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the communication of data associated with each stimulus. In one embodiment, the stimuli management module 212 processes the received stimuli in accordance with a predetermined configuration (e.g., the configuration 230) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on processing of data by any of its nodes. In some examples, the processing of a stimulus (such as a stimulus of the set of stimuli 236) results in the generation, communication, or processing of data that further results in one or more outcomes (e.g., the outcome 240) being generated. Such outcomes are either handled internally by one or more modules in the overlay system 202 or communicated via the interface module 204 as an external outcome. In one embodiment, all stimuli and corresponding outcomes are recorded for auditing and post-processing purposes by, for example, the operations module 224 of the overlay system 202.

The overlay management module 214 may include suitable logic, circuitry, interfaces, and/or code, executable by the circuitry, configured to manage all overlays within the overlay system 202. Operations performed by the overlay management module 214 include overlay storage management, overlay structure modeling, overlay logic creation and execution, and overlay loading and unloading (within the executable graph-based model 100). The overlay management module 214 is communicatively coupled (e.g., connected either directly or indirectly) to one or more other modules within the overlay system 202 to complete some or all of these operations. For example, overlays can be persisted in some form of physical storage using the storage management module 218 (as described in more detail below). As a further example, overlays can be compiled and preloaded into memory via the memory management module 216 for faster run-time execution.

The memory management module 216 may include suitable logic, circuitry, interfaces, and/or code, executable by the circuitry, configured to manage and optimize the memory usage of the overlay system 202. The memory management module 216 thus helps to improve the responsiveness and efficiency of the processing performed by one or more of the modules within the overlay system 202 by optimizing the memory handling performed by these modules. The memory management module 216 uses direct memory or some form of distributed memory management architecture (e.g., a local or remote caching solution). Additionally, or alternatively, the memory management module 216 deploys multiple different types of memory management architectures and solutions (e.g., reactive caching approaches such as lazy loading or a proactive approach such as write-through cache may be employed). These architectures and solutions are deployed in the form of a flat (single-tiered) or multi-tiered caching architecture where each layer of the caching architecture may be implemented using a different caching technology or architecture solution approach. In such implementations, each cache or caching tier may be configured (e.g., by the configuration 230) independent of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 216 is communicatively coupled (e.g., connected either directly or indirectly) to one or more overlays within the executable graph-based model 100.

The storage management module 218 may include suitable logic, circuitry, interfaces, and/or code, executable by the circuitry, configured to manage the temporary or permanent storage of data associated with the overlay system 202. The storage management module 218 is any suitable low-level storage device solution (such as a file system) or any suitable high-level storage technology such as another database technology (e.g., relational database management system (RDBMS) or NoSQL database). The storage management module 218 is directly connected to the storage device upon which the relevant data is persistently stored. For example, the storage management module 218 may directly address the computer-readable medium (e.g., hard disk drive, external disk drive, or the like) upon which the data is being read or written. Alternatively, the storage management module 218 is connected to the storage device via a network such as the network 238. As will be described in more detail later in the present disclosure, the storage management module 218 uses manifests to manage the interactions between the storage device and the modules within the overlay system 202. In one embodiment, the storage management module 218 is communicatively coupled (e.g., connected either directly or indirectly) to one or more overlays within the executable graph-based model 100. Throughout the description, the term ‘storage device’ is used interchangeably with the term ‘storage element’.

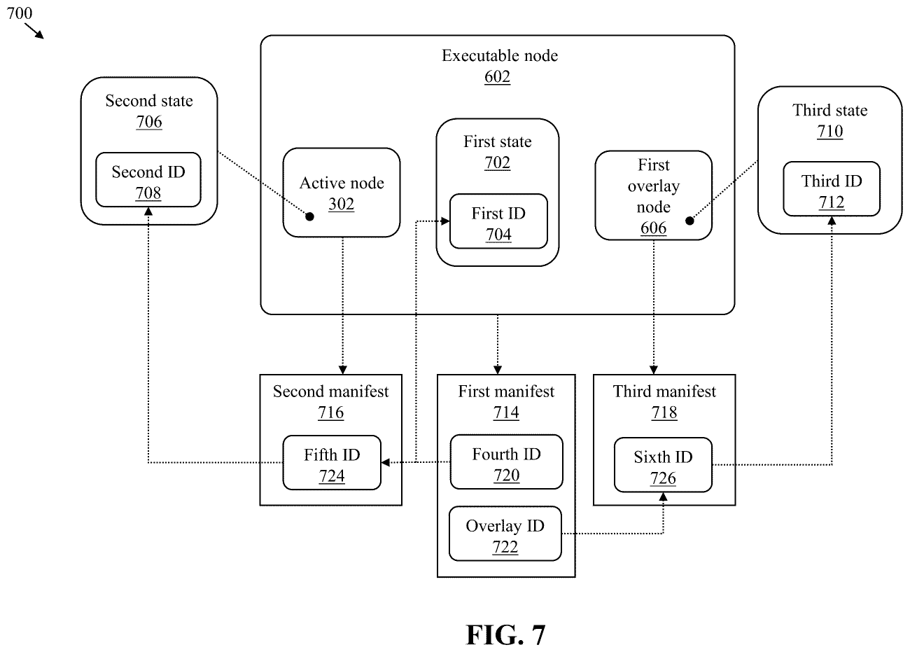

As described, storage, loading, and unloading of the executable graph-based model 100 or one or more components thereof is facilitated by the memory management module 216 and the storage management module 218. The memory management module 216 and the storage management module 218 may facilitate such operations by interacting with the storage device that stores the executable graph-based model 100. The overlay system 202 further includes a plurality of manifest storages. The manifest storages are used by the memory management module 216 and the storage management module 218 to facilitate storage manifest states (including manifest template states and manifest instance states) of nodes. The storage element may include a primary storage and a secondary storage. The primary storage may store the executable graph-based model 100 and may also store nodes that are loaded in the executable graph-based model 100. The secondary storage may store node states, manifests, and manifest states associated with nodes that are unloaded from the executable graph-based model 100. Storage and retrieval of nodes are described in detail in conjunction with FIG. 7.

The security module 220 may include suitable logic, circuitry, interfaces, and/or code, executable by the circuitry, configured to manage the security of the overlay system 202. This includes security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 220 can enforce a hypertext transfer protocol secure (HTTPS) protocol with the necessary certification. As a further example, if the data or information associated with the data associated with the overlay system 202 contains Personally Identifiable Information (PII) or Protected Health Information (PHI), the security module 220 may implement one or more layers of data protection to ensure that the PII or PHI are correctly processed and stored. In an additional example, in implementations whereby the overlay system 202 operates on United States of America citizen medical data, the security module 220 may enforce additional protections or policies as defined by the United States Health Insurance Portability and Accountability Act (HIPAA). Similarly, if the overlay system 202 may be deployed in the European Union (EU), the security module 220 may enforce additional protections or policies to ensure that the data processed and maintained by the overlay system 202 complies with the General Data Protection Regulation (GDPR). In one embodiment, the security module 220 is communicatively coupled (e.g., connected either directly or indirectly) to one or more overlays within the executable graph-based model 100, thereby directly connecting security execution to the data/information in the executable graph-based model 100. The security module 220 thus acts as a centralized coordinator that works in conjunction with the overlay management module 214 for managing and executing security-based overlays.

The latch management module 222 may include suitable logic, circuitry, interfaces, and/or code, executable by the circuitry, configured to manage design and implementation of latch nodes in the overlay system 202. The latch management module 222 may be further configured to facilitate one or more operations associated with execution of one or more operations associated with the latch nodes in the executable graph-based model 100.

The operations module 224 may include suitable logic, circuitry, interfaces, and/or code, executable by the circuitry, configured to track operational metrics and the behavior of all modules of the overlay system 202. Operational metrics of a module are indicative of statistics associated with the performance of the module while performing an operation (for example, communication, data processing, stimulus processing, or the like).

The data management module 226 may include suitable logic, circuitry, interfaces, and/or code, executable by the circuitry, configured to manage all data or information within the overlay system 202 (e.g., the dataset 234) for a given application. Operations performed by the data management module 226 include data loading, data unloading, data modeling, and data processing. The data management module 226 is communicatively coupled (e.g., connected either directly or indirectly) to one or more other modules within the overlay system 202 to complete some or all of these operations. For example, data storage is handled by the data management module 226 in conjunction with the storage management module 218.

The template management module 228 may include suitable logic, circuitry, interfaces, and/or code, executable by the circuitry, configured to enable the overlay system 202 to implement a templated version of one or more nodes of the executable graph-based model 100. The template management module 228 may be configured to create one or more predefined templates in the executable graph-based model 100. The template management module 228 may be further configured to generate one or more node instances of the predefined templates for the implementation of a templated version of the executable graph-based model 100. Notably, the template management module 228 ensures ontology integrity by enforcing the structure and rules of a template when generating instances of the template at run-time. Ontology integrity refers to the consistency, accuracy, and correctness of an ontology. Thus, the template management module 228 ensures that the consistency, accuracy, and correctness of the ontology of the executable graph-based model 100 is maintained while generating the instances of the template at run-time. The template management module 228 may be communicatively coupled (i.e., connected either directly or indirectly) to one or more nodes and/or one or more overlays within the executable graph-based model 100.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include, but are not limited to, a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or functional programming languages.

Although it is described that the overlay system 202 includes a single executable graph-based model (e.g., the executable graph-based model 100), the scope of the present disclosure is not limited to it. In other embodiments, the overlay system 202 may include more than one executable graph-based model, without deviating from the scope of the present disclosure. In such a scenario, each executable graph-based model is implemented and managed in a manner that is similar to the executable graph-based model 100.

Having described the overlay system 202 for executing and managing executable graph-based models, the description will now turn to the elements of an executable graph-based model; specifically, the concept of a node. Unlike conventional graph-based systems, all elements (e.g., data, overlays, etc.) within the executable graph-based model (e.g., the executable graph-based model 100) are implemented as nodes. As will become clear, this allows executable graph-based models to be flexible, extensible, and highly configurable.

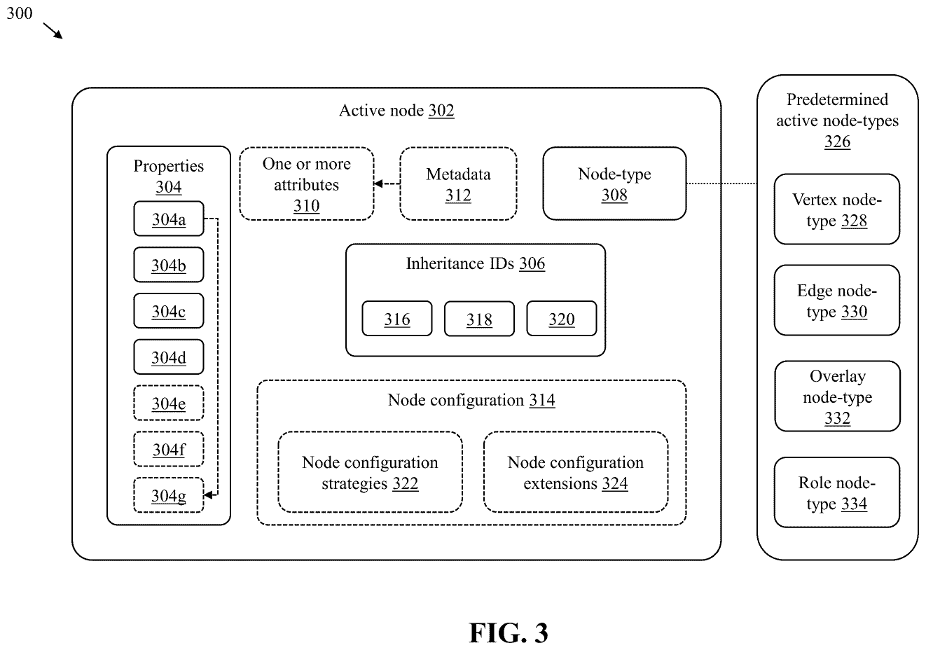

FIG. 3 is a block diagram 300 that illustrates a generic structure of an active node 302 within the executable graph-based model 100, consistent with disclosed embodiments of the present disclosure. Referring to FIG. 3, the active node 302 corresponds to a node of the executable graph-based model 100.

The active node 302 further corresponds to the core structure of the executable graph-based model 100 and forms the foundational building block for all data and processing logic within the executable graph-based model 100. The active node 302 includes properties 304, inheritance IDs 306, and a node-type 308. The active node 302 optionally includes one or more attributes 310, metadata 312 associated with the one or more attributes 310, and a node configuration 314.

The properties 304 of the active node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the active node 302 include an abstract flag 316, a leaf flag 318, and a root flag 320. The node configuration 314 optionally includes one or more node configuration strategies 322 and one or more node configuration extensions 324.

The unique ID 304a is unique for each node within the executable graph-based model 100. The unique ID 304a is used to register, manage, and reference the active node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the active node 302 is incremented when the active node 302 undergoes transactional change. This allows the historical changes between versions of the active node 302 to be tracked by modules or overlays within the overlay system 202. The namespace 304c of the active node 302, along with the name 304d of the active node 302, is used to help organize nodes within the executable graph-based model 100. That is, the active node 302 is assigned a unique name 304d within the namespace 304c such that the name 304d of the active node 302 need not be unique within the entire executable graph-based model 100, only within the context of the namespace 304c to which the active node 302 is assigned. The active node 302 optionally includes the one or more icons 304e which are used to provide a visual representation of the active node 302 when visualized via a user interface. The one or more icons 304e can include icons at different resolutions and display contexts such that the visualization of the active node 302 is adapted to different display settings and contexts. The active node 302 also optionally includes one or more labels 304f which are used to override the name 304d when the active node 302 is rendered or visualized.

The active node 302 supports the concept of inheritance of data and processing logic associated with any other node of the executable graph-based model 100 that is inherited by the active node 302. This allows the behavior and functionality of the active node 302 to be extended or derived from the inherited node of the executable graph-based model 100. The inheritance IDs 306 of the active node 302 indicate the inheritance-based information, which may apply to the active node 302. The inheritance IDs 306 comprise a set of Boolean flags that identify the inheritance structure of the active node 302. The abstract flag 316 allows the active node 302 to support the construct of abstraction. When the abstract flag 316 takes a value ‘true’, the active node 302 is flagged as abstract that is to say that it cannot be instantiated or created within an executable graph-based model (e.g., the executable graph-based model 100). Thus, in an instance when the active node 302 has the abstract flag 316 set to ‘true’, the active node 302 may only form the foundation of other nodes that inherit therefrom. By default, the abstract flag 316 of the active node 302 is set to ‘false’. The leaf flag 318 is used to indicate whether any other node may inherit from the active node 302. If the leaf flag 318 is set to ‘true’, then no other node may inherit from the active node 302 (but unlike an abstract node, a node with the leaf flag 318 set to ‘true’ may be instantiated and created within the executable graph-based model 100). The root flag 320 is used to indicate whether the active node 302 inherits from any other node. If the root flag 320 is set to ‘true’, the active node 302 does not inherit from any other node. The active node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node-type. The node-type 308 of the active node 302 is used to extend the functionality of the active node 302. All nodes within the executable graph-based model 100 comprise a node-type that defines additional data structures and implements additional executable functionality. A node-type thus includes data structures and functionality that are common across all nodes that share that node-type. Therefore, composition of a node with a node-type improves extensibility by allowing the generation of specialized node functionalities for specific application areas. Such extensibility is not present in prior art graph-based models. As illustrated in FIG. 3A, the active node 302 and the node-type 308 are one logical unit that is not separated in the context of an executing system at run-time (e.g., in the context of execution of an executable graph-based model).

FIG. 3 further shows the plurality of predetermined active node-types 326 which provides a non-exhaustive list of node-types for the node-type 308 associated with the active node 302. The plurality of predetermined active node-types 326 includes a vertex node-type 328 and an edge node-type 330. The vertex node-type 328 (also referred to as a data node-type or a value node-type) includes common data structures and functionality related to the ‘things’ modeled in the graph (e.g., the data). The edge node-type 330 includes common data structures and functionality related to coupling/linking/associating two or more nodes. A node having the edge node-type 330 may connect two or more nodes and thus the edge node-type 330 constructs associations and connections between nodes (for example, objects or ‘things’) within the executable graph-based model 100. The edge node-type 330 is not restricted to the number of nodes that may be associated or connected by a node having the edge node-type 330. The data structures and functionality of the edge node-type 330 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween.

The plurality of predetermined active node-types 326 further includes an overlay node-type 332 and a role node-type 334. As will be described in more detail below, a node with the overlay node-type 332 is used to extend the functionality of a node, such as the active node 302, to incorporate processing logic. Unlike non-overlay nodes, an overlay node (e.g., a node having the overlay node-type 332) includes processing logic which determines the functionality of the overlay node. The processing logic of an overlay node includes a block of executable code, or instructions, which carries out one or more operations associated with the communication of data within the executable graph-based model 100. The block of executable code is pre-compiled code, code that requires interpretation at run-time, or a combination of both. Different overlay nodes provide different processing logic to realize different functionality. For example, an encryption overlay node includes an encryption technique using which an associated node is to be protected/secured and processing logic for facilitating such security/protection of the associated node.

The role node-type 334 defines a connective relationship between two nodes, for example, an edge node and a first vertex node. A node with the role node-type 334 defines a relationship without expressly defining the first vertex node to which the edge node connects. A number of roles (and thus a number of connections) that an edge node-type can have is not limited.

The one or more attributes 310 correspond to the data associated with the active node 302 (e.g., the data represented by the active node 302 within the executable graph-based model 100 as handled by the data management module 226). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, or a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the active node 302 shown in FIG. 3). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with the reference attribute behavior includes appropriate information to obtain a reference data set of possible values. The derived attribute behavior is a behavior that allows read-only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the active node 302 further includes the metadata 312 (e.g., data stored as a name, a confidentiality indicator for indicating data as sensitive and/or confidential, an average processing time required for processing data, or the like) which is associated with either the active node 302 or an attribute (for example, the one or more attributes 310) of the active node 302. An attribute within the one or more attributes 310 may either have an independent state or a shared state. That is to say, an attribute may be a value-shared attribute or a non-value-shared attribute. An independent attribute has data that is not shared with any other active node within the executable graph-based model 100. Conversely, a shared attribute has data that is shared with one or more other active nodes within the executable graph-based model 100. For example, if two nodes within the executable graph-based model 100 comprise a shared-data attribute with a value state shared by both nodes, then updating the data (e.g., the value) of this shared attribute may be reflected across both nodes.

The node configuration 314 provides a high degree of configurations for the different elements of the active node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the active node 302, which creates message source IDs. A further example of a concrete node configuration strategy is a versioning strategy, associated with the configuration of the version ID 304b of the active node 302, which supports major and minor versioning (depending on the type of transactional change incurred by the active node 302). The versioning strategy may be adapted to a native filing system of a user device hosting the overlay system 202 or a third-party data storage (for example, Snowflake®, or the like) associated with the overlay system 202. All attribute configurations examples of node configuration extensions 324.

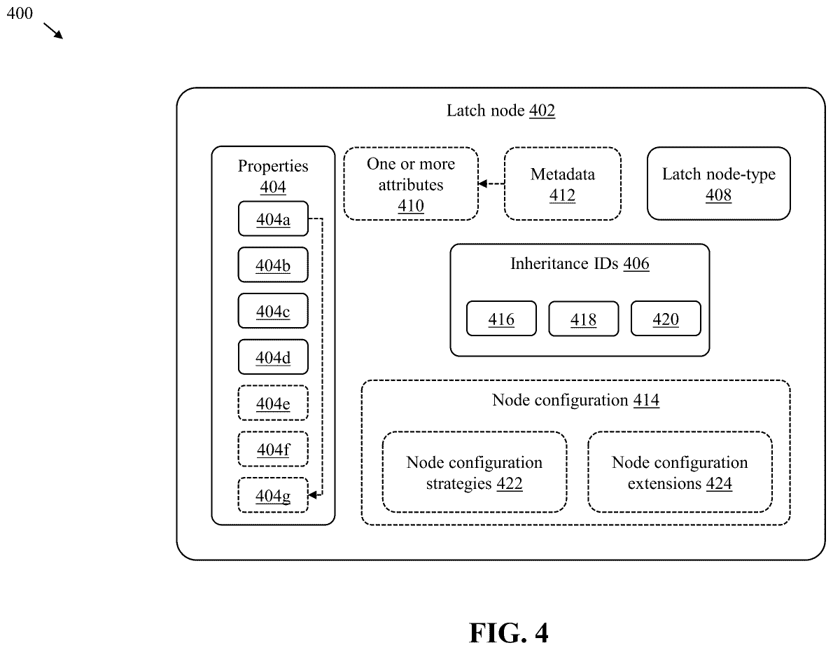

FIG. 4 is a block diagram 400 that illustrates a generic structure of a latch node 402 within the executable graph-based model 100, consistent with disclosed embodiments of the present disclosure. Referring to FIG. 4, the latch node 402 corresponds to the core structure of the executable graph-based model 100 and forms the foundational building block for various data and processing logics within the executable graph-based model 100. The latch node 402 includes properties 404, inheritance IDs 406, and a latch node-type 408. The latch node 402 optionally includes one or more attributes 410, metadata 412 associated with the one or more attributes 410, and a node configuration 414.

The properties 404 of the latch node 402 include a unique ID 404a, a version ID 404b, a namespace 404c, and a name 404d. The properties 404 optionally include one or more icons 404e, one or more labels 404f, and one or more alternative IDs 404g.

The properties 404 of the latch node 402 is same as the properties 304 of the active node 302. In other words, the unique ID 404a, the version ID 404b, the namespace 404c, the name 404d, the one or more icons 404e, the one or more labels 404f, and the one or more alternative IDs 404g are same as the unique ID 304a, the version ID 304b, the namespace 304c, the name 304d, the one or more icons 304e, the one or more labels 304f, and the one or more alternative IDs 304g, respectively, of the active node 302.

The inheritance IDs 406 of the latch node 402 include an abstract flag 416, a leaf flag 418, and a root flag 420. The inheritance IDs 406 of the latch node 402 is the same as the inheritance IDs 306 of the active node 302. In other words, the abstract flag 416, the leaf flag 418, and the root flag 420 are same as the abstract flag 316, the leaf flag 318, and the root flag 320 of the active node 302.

The node configuration 414 optionally includes one or more node configuration strategies 422 and one or more node configuration extensions 424. The node configuration 414 is same as the node configuration 314 of the active node 302. In other words, the one or more node configuration strategies 422 and one or more node configuration extensions 424 of the latch node 402 are same as the node configuration strategies 322 and one or more node configuration extensions 324 of the active node 302.

As mentioned above, the latch node 402 has the latch node-type 408. Thus, the latch node 402 may couple at least two active nodes and facilitate a transfer of at least one state change associated with one active node to the other active node based on a set of conditions associated with latch node 402. A state change associated with an active node may correspond to a state change in a node element of the corresponding active node. A node element of the active node 302 may correspond to one of the unique ID 304a, the version ID 304b, the namespace 304c, the name 304d, the one or more icons 304e, the one or more labels 304f, the one or more attributes 310, the metadata 312, the node configuration 314, the one or more node configuration strategies 322, and the one or more node configuration extensions 324.

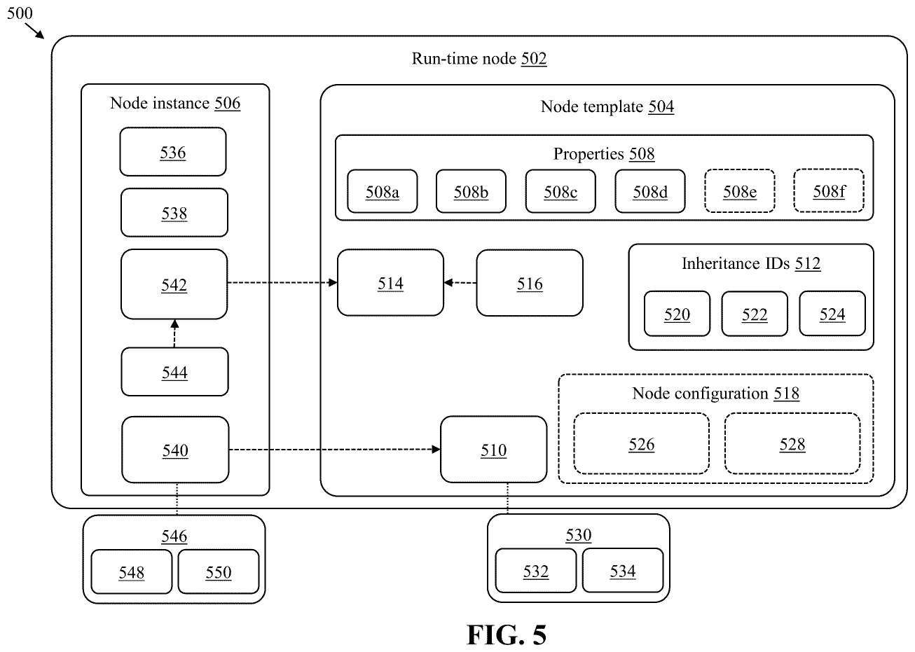

FIG. 5 is a block diagram 500 that illustrates a generic structure of a run-time node 502 within the executable graph-based model 100, consistent with disclosed embodiments of the present disclosure. Referring to FIG. 5, the run-time node 502 corresponds to the core structure of the executable graph-based model 100 and forms the foundational building block for all data and processing logic within the executable graph-based model 100. The run-time node 502 is shown to include a node template 504 and a node instance 506. The node instance 506 is generated according to the node template 504. The node template 504 forms a data structure for the node instance 506. The run-time node 502 shown in FIG. 5 is a compositional structure that is generated and executed, at run-time as part of the executable graph-based model 100. In other words, the node template 504 is defined as ‘offline’ and the node instance 506 and the run-time node 502 are run-time structures that are dynamically generated during execution of the executable graph-based model 100.

The node template 504 comprises a predetermined node structure. Further, the node template 504 defines one or more rules that govern the generation of the node instance 506. The node instance 506 is an implementation of the node template 504. In other words, the node instance 506 is generated based on the predetermined node structure and the one or more rules of the node template 504. The node template 504 may not be modified during the execution but may be modified during offline mode or at rest. During execution, only the node instance 506 of the run-time node 502 may be modified.

The node template 504 includes properties 508, a node-type template 510, inheritance IDs 512, and one or more attribute templates 514. The node template 504 may optionally include metadata 516 and a node configuration 518. The properties 508 of the node template 504 include a unique identifier (ID) 508a, a version ID 508b, a namespace 508c, a name 508d, and optionally include one or more icons 508e and one or more labels 508f. The inheritance IDs 512 may comprise an abstract flag 520, a leaf flag 522, and a root flag 524. The node configuration 518 optionally comprises one or more node configuration strategies 526 and/or one or more node configuration extensions 528. FIG. 5 further shows a plurality of predetermined node-type templates 530 of the node-type template 510. The plurality of predetermined node-type templates 530 includes an active node-type template 532 and a latch node-type template 534. Further, the node instance 506 includes a unique ID 536, a version ID 538, a node-type instance 540, and one or more attribute instances 542. The node instance 506 may optionally include metadata 544. FIG. 5 further shows a plurality of predetermined node-type instances 546 of the node-type instance 540. The plurality of predetermined node-type instances 546 includes an active node-type instance 548 and a latch node-type instance 550.

The unique ID 508a is unique for each node template within the executable graph-based model 100. Similarly, the unique ID 536 is unique for each node instance within the executable graph-based model 100. The unique ID 508a and the unique ID 536 are used to register, manage, and reference the node template 504 and the node instance 506, respectively, within the overlay system 202. The version ID 508b of the node template 504 is incremented when the node template 504 undergoes transactional change. Similarly, the version ID 538 of the node instance 506 is incremented when the node instance 506 undergoes transactional change. The namespace 508c of the node template 504, along with the name 508d of the node template 504, is used to help organize node templates within the executable graph-based model 100. That is, the node template 504 is assigned a unique name 508d within the namespace 508c such that the name 508d of the node template 504 need not be unique within the entire executable graph-based model 100, only within the context of the namespace 508c to which the node template 504 is assigned. The node template 504 optionally comprises one or more icons 508e which are used to provide a visual representation of the node template 504. The one or more icons 508e may include icons at different resolutions and display contexts such that the visualization of the node is adapted to different display contexts and settings. The node template 504 also optionally comprises the one or more labels 508f which are used to override the name 508d when the node template 504 is rendered or visualized.

The node template 504 supports the software development feature of multiple inheritance by maintaining references (not shown) to zero or more other node templates, which then act as the base of the node template 504. This allows the behavior and functionality of a node template to be extended or derived from one or more other node templates within an executable graph-based model (such as the executable graph-based model 100). The node instance 506 likewise supports multiple inheritance because it is an instance representation of the node template 504. The multiple inheritance structure of the node instance 506 is, however, limited to the corresponding instance realization of the multiple inheritance structure defined by the node template 504, i.e., one node instance 506 is created and managed for each node template 504 defined in the inheritance hierarchy for a node instance of a node template.

The inheritance IDs 512 of the node template 504 indicate the inheritance-based information, which is applicable, or can be applicable, to the node template 504. The inheritance IDs 512 have a description that is similar to the inheritance IDs 306. The abstract flag 520 has a description that is similar to the abstract flag 316, the leaf flag 522 has a description that is similar to the leaf flag 318, and the root flag 524 has a description that is similar to the root flag 320.

All elements within the executable graph-based model 100 are defined as node templates or node instances. The functionality of the node template 504 and the node instance 506 are realized due to the use of the node-type template 510 and the node-type instance 540. The node-type template 510 of the node template 504 is used to extend the functionality of the node template 504 by defining the standard set of capabilities, including data and associated behavior.

The run-time node 502 with the active node-type template 532 and the active node-type instance 548 may correspond to a templated version of the active node 302. Similarly, the run-time node 502 with the latch node-type template 534 and the latch node-type instance 550 may correspond to a templated version of the latch node 402.

The one or more attribute templates 514 corresponds to the data defined by the node template 504. For example, the one or more attribute templates 514 may define the names and value types (e.g., integer, string, float, etc.) of one or more attributes but not the values of these attributes. The values of the one or more attribute templates 514 may be defined by the one or more attribute instances 542 of the node instance 506 through one or more values or instance values. For example, the node template 504 may define a string attribute ‘surname’ and the corresponding node instance 506 may assign the instance value ‘Bell-Richards’ to this string attribute. Each attribute instance of the one or more attribute instances 542 is associated with an attribute template of the one or more attribute templates 514. The node template 504 may define one or more default values for the one or more attribute templates 514. The default values correspond to the values that the attributes take if no value is assigned. The metadata 516 (e.g., data stored as a name, a value type, and a value triplet) is associated with either the node template 504 or one or more of the one or more attribute templates 514 of the node template 504. Similarly, the node instance 506 also optionally comprises the metadata 544 (e.g., data stored as a name, a value type, and a value triplet) which is associated with either the node instance 506 or one or more of the one or more attribute instances 542.

The node configuration 518 provides a high degree of configurability for the different elements of a node template and/or a node instance. The node configuration 518 optionally includes the one or more node configuration strategies 526 and/or the one or more node configuration extensions 528 which are complex data types. An example of a concrete node configuration strategy is an ID strategy, associated with the configuration of the unique ID 508a of the node template 504. A further example of a concrete node configuration strategy is a versioning strategy, associated with the configuration of the version ID 508b of the node template 504 which supports major and minor versioning (depending on the type of transactional change incurred). The versioning strategy may be adapted to a native filing system of a user device hosting the overlay system 202 or a third-party data storage (for example, Snowflake®, or the like) associated with the overlay system 202.

Although it is provided that the node template 504 is associated with the node instance 506, the scope of the present disclosure is not limited to it. In other embodiments, the node template 504 may be further associated with two or more node instances where the two or more node instances correspond to two or more implementations of the node template 504.

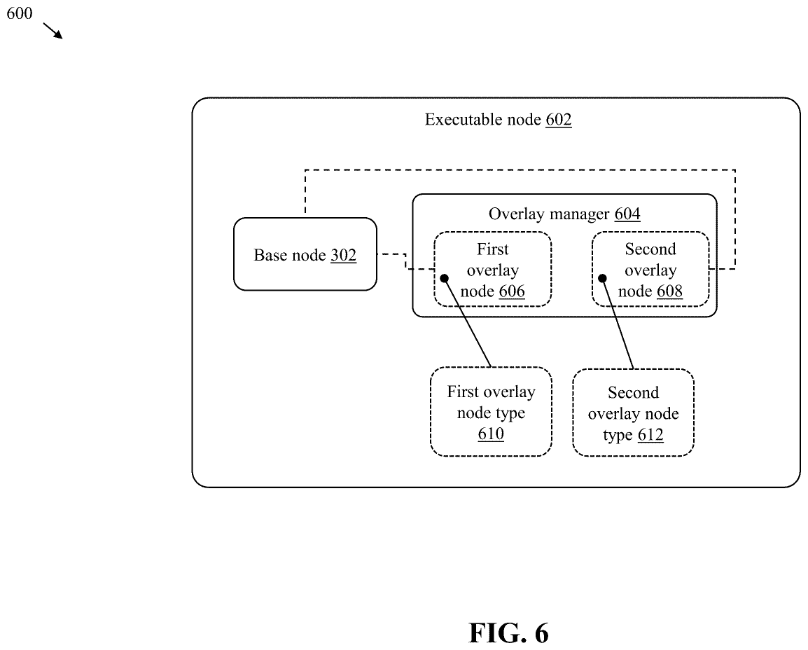

FIG. 6 is a block diagram 600 that illustrates an executable node 602 within the executable graph-based model 100, consistent with disclosed embodiments of the present disclosure. Referring to FIG. 6, the executable node 602 is shown to include a base node (e.g., the active node 302) and an overlay manager 604. For the sake of ongoing discussion, the base node corresponds to the active node 302, and is hereinafter referred to as the “base node 302”. The base node 302 when extended by way of one or more overlay nodes becomes the executable node 602.

The overlay manager 604 includes a first overlay node 606 and a second overlay node 608. The executable node 602 provides processing functionality (e.g., processing logic) to the base node 302 via one or more associated overlay nodes (for example, the first and second overlay nodes 606 and 608). Beneficially, the data and processing capability of the base node 302 may be dynamically and significantly extended using the concept of an executable node (for example, the executable node 602). As shown, the first overlay node 606 has a first overlay node-type 610, and the second overlay node 608 has a second overlay node-type 612. Examples of overlay node-type include, but are not limited to, an encryption overlay node-type, a publisher overlay node-type, a handler overlay node-type, an obfuscation overlay node-type, or the like.

A node with the encryption overlay node-type is an encryption overlay node that is indicative of an encryption technique using which an associated node is to be secured. The encryption overlay node also includes processing logic to secure a corresponding node. Examples of the encryption technique include a symmetric encryption algorithm, an asymmetric encryption algorithm, a combination of these, or any other encryption technique. A node with the publisher overlay node-type is a publisher overlay node that is indicative of an operation of publishing an output of an associated node. The publisher overlay node also includes processing logic to publish the output.

Although, the executable node 602 is shown to include the first and second overlay nodes 606 and 608, in other embodiments, the executable node 602 may include any number of overlay nodes, without deviating from the scope of the present disclosure.

The executable node 602 extends the base node 302 (or is a subtype of the base node 302) such that all the functionality and properties of the base node 302 are accessible to the executable node 602. The executable node 602 also dynamically extends the functionality of the base node 302 by associating the overlay nodes maintained by the overlay manager 604 with the base node 302. The executable node 602 may thus be considered a combination of the base node 302 and the first and second overlay nodes 606 and 608. The executable node 602 may be alternatively referred to as a node with overlay(s). Therefore, the executable node 602 acts as a decorator of the base node 302 adding the functionality of the overlay manager 604 to the base node 302.

It will be apparent to a person skilled in the art that the base node 302 refers to any suitable node within the executable graph-based model 100. As such, the base node 302 may be a node having a node-type such as a vertex node-type, an edge node-type, an overlay node-type, or the like. Alternatively, the base node 302 may be an executable node such that the functionality of the (executable) base node 302 is dynamically extended. In this way, complex and powerful processing functionality can be dynamically generated by associating and extending overlay nodes.

The overlay manager 604 registers and maintains one or more overlay nodes (such as the first overlay node 606 and the second overlay node 608) associated with the base node 302. The assignment of the first and second overlay nodes 606 and 608 to the base node 302 (via the overlay manager 604) endows the base node 302 with processing logic and executable functionality defined within the first and second overlay nodes 606 and 608.

Extending the functionality of a base node through one or more overlay nodes is at the heart of the overlay system 202. As illustrated in FIG. 2, the data (e.g., a vertex node as represented by the base node 302 in FIG. 6) and the functionality that acts upon that data (e.g., an overlay node) may be separated and independently maintained offline, but at run-time, an association between the data node and the overlay node is determined and an executable node is generated (e.g., the executable node 602 shown in FIG. 6).

It will be apparent to a person skilled in the art that functionalities of the first and second overlay nodes 606 and 608 may be performed by a single overlay node that includes processing logic associated with both the first and second overlay nodes 606 and 608.

It will be apparent to a person skilled in the art that the list of overlay types is not exhaustive and the number of different overlay types that may be realized is not limited. Because an overlay node is itself a node, all functionality of a node described in relation to the base node 302 is thus applicable to an overlay node. For example, an overlay node includes a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

An overlay node, such as the first overlay node 606 or the second overlay node 608, is not bound to a single executable node or a single executable graph-based model (unlike nodes that have non-overlay node-types). This allows overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays. Also, a single overlay node may be associated with multiple executable nodes. Thus, the overlay node and functionality thereof may be shared among the multiple executable nodes.

The overlay manager 604 of the executable node 602 is responsible for executing all overlays registered therewith. The overlay manager 604 also coordinates the execution of all associated overlay nodes. As shown in FIG. 6, the executable node 602 associates the base node 302 with two overlay nodes that is the first overlay node 606 and the second overlay node 608. Thus, the overlay manager 604 employs a strategy to manage the potentially cascading execution flow. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies are defined and registered with the overlay manager 604 and are associated with an overlay via a node configuration extension for the overlay.

Although FIG. 6 describes that the executable node 602 includes the base node 302, the scope of the present disclosure is not limited to it. In various embodiments, the executable node 602 may include the latch node 402. In such embodiments, the executable node 602 provides additional processing functionality to the latch node 402 via the first and second overlay nodes 606 and 608.

FIG. 7 is a block diagram 700 that illustrates a composition of the executable node 602 that enables persistent storage of data and the processing logic associated therewith, consistent with disclosed embodiments of the present disclosure.

As described in conjunction with FIG. 6, the executable node 602 includes the base node 302 and one or more overlay nodes (e.g., the first and second overlay nodes 606 and 608). For the brevity of the ongoing description, the persistent storage is explained for the executable node 602 including only the first overlay node 606. One or more operations performed for ensuring the persistence of the first overlay node 606 may be performed for the second overlay node 608 as well.

Referring to FIG. 7, the executable node 602 includes the base node 302 and the first overlay node 606. The executable node 602 has a corresponding first state 702 having a first ID 704. The base node 302 has a second state 706 having a second ID 708, and the first overlay node 606 has a third state 710 having a third ID 712. A manifest (for example, first through third manifests 714-718) is generated for each of the base node 302, the executable node 602, and the first overlay node 606. In an embodiment, the manifests may be generated by the storage management module 218. The first manifest 714 is associated with the executable node 602 and has a fourth ID 720 and an overlay ID 722. The second manifest 716 is associated with the base node 302 and has a fifth ID 724. The third manifest 718 is associated with the first overlay node 606 and has a sixth ID 726. Further, the manifests are stored at respective storage locations that may be centralized or distributed storage locations associated with the overlay system 202. The manifests may be stored by the storage management module 218.

The first state 702 of the executable node 602 includes data required to reconstruct the executable node 602 (e.g., attributes, properties, etc.). The first state 702 of the executable node 602 is persistently stored along with the first ID 704. The first manifest 714 is generated for the executable node 602 and has (i) the fourth ID 720 (which is the same as the first ID 704), (ii) the storage location of the first state 702 of the executable node 602, and (iii) the overlay ID 722 (which is the same as the sixth ID 726). Notably, the fourth ID 720 is the same as the first ID 704 and the fifth ID 724, hence, the first manifest 714 includes the ID of the state of the base node 302 and the executable node 602. Further, the overlay ID 722 is the same as the sixth ID 726 of the state of the first overlay node 606. Therefore, the first manifest 714 may be used to identify and retrieve the states of the base node 302, the executable node 602, and the first overlay node 606. Subsequently, the retrieved states may be used to reconstruct the executable node 602 and the first overlay node 606. In an instance, the executable node 602 may be further extended to include additional overlay nodes. In such an instance, the first manifest 714 may include state IDs of the additional overlay nodes as well. A first manifest state (not shown) is then generated for the first manifest 714 and persistently stored along with the fourth ID 720.

The second state 706 of the base node 302 includes data required to reconstruct the base node 302 (e.g., attributes, properties, etc.) and is persistently stored along with the second ID 708. The second manifest 716 is generated for the base node 302 and has the fifth ID 724 and the storage location of the second state 706 of the base node 302. The second ID 708 of the second state 706 and the fifth ID 724 of the second manifest 716 are the same as the first ID 704 of the first state 702 of the executable node 602 (which is also the same as the fourth ID 720 of the first manifest 714 of the executable node 602). As mentioned above, along with the first state 702, the first manifest 714 may also be used to identify and retrieve the second manifest 716 which in turn may be used to identify the second state 706 of the base node 302. A second manifest state (not shown) is then generated for the second manifest 716 and persistently stored along with the fifth ID 724. Thus, the states, manifests, and manifest states for the executable node 602 and the base node 302 include the same, shared, ID. A shared ID can be used in this instance because the states, manifests, and manifest states are stored separately. The separate storage of the states, manifests, and manifest states exhibit a distributed architecture of the overlay system 202.

The third state 710 of the first overlay node 606 includes data required to reconstruct the first overlay node 606 (e.g., attributes, properties, processing logic, etc.) and is persistently stored along with the third ID 712. The third manifest 718 is generated for the first overlay node 606 and includes the sixth ID 726, which is the same as the third ID 712. Therefore, the first manifest 714 may be further used to identify and retrieve the third manifest 718 which in turn may be used to identify and retrieve the third state 710 of the first overlay node 606. A third manifest state (not shown) is then generated for the third manifest 718 and is persistently stored along with the sixth ID 726.

In operation, when the executable node 602 is to be loaded, the transaction module 208, in conjunction with the storage management module 218, may execute one or more operations to retrieve the first manifest state stored at a known storage location. Based on the first manifest state, the storage management module 218 may re-construct the first manifest 714 which includes the fourth ID 720 which is the same as the fifth ID 724 of the second manifest 716. Based on the fifth ID 724, the storage management module 218 may identify the second manifest state and may generate the second manifest 716 based on which the second state 706 is identified. Subsequently, the base node 302 is loaded and the storage management module 218 may determine that the base node 302 is a node with overlay. Based on the fourth ID 720 (that is the same as the first ID 704 of the first state 702 of the executable node 602) of the first manifest 714, the first state 702 is identified and retrieved. Subsequently, the executable node 602 is loaded. Moreover, based on the overlay ID 722 (that is the same as the sixth ID 726 of the third manifest 718) of the first manifest 714, the third manifest state is identified and the third manifest 718 is generated. Subsequently, based on the sixth ID 726 (that is the same as the third ID of the third state 710) of the third manifest 718, the third state 710 is identified and retrieved. Based on the third state 710, the first overlay node 606 is reconstructed and loaded in the executable graph-based model 100.

Based on a context of a stimulus (for example, a stimulus of the set of stimuli 236) associated with the overlay system 202, the processing circuitry (such as the context module 210) may determine an ID that is the same as the fifth ID 724. Based on the determined ID, the processing circuitry (such as the memory management module 216 and the storage management module 218) may identify the second manifest 716. Subsequently, the processing circuitry (such as the memory management module 216 and the storage management module 218) may identify the second state 706 which has the second ID 708 that matches the fifth ID 724. Further, the processing circuitry (such as the memory management module 216 and the storage management module 218) may retrieve the second state 706 associated with the second manifest 716 from a corresponding storage element. Subsequently, the processing circuitry (such as the memory management module 216 and the storage management module 218) may determine, by checking the manifest storage(s) associated with the overlay system 202, whether there is another manifest (such as the first manifest 714 of the executable node 602) with an ID that matches the second ID 708 and the fifth ID 724. Notably, the first manifest 714 includes storage locations of each overlay node (for example, the first overlay node 606) of the executable node 602. Based on the overlay ID 722 included in the first manifest 714 that matches the sixth ID 726 included in the third manifest 718, the processing circuitry (such as the memory management module 216 and the storage management module 218) may identify and retrieve the third manifest 718 from a manifest storage of a plurality of manifest storages of the overlay system 202. Subsequently, the processing circuitry (such as the memory management module 216 and the storage management module 218) may identify the third state 710 which has the third ID 712 that matches the sixth ID 726. Further, the processing circuitry (such as the memory management module 216 and the storage management module 218) may retrieve the third state 710 associated with the third manifest 718 from a corresponding storage element. To determine whether the first overlay node 606 has an overlay node associated therewith, the processing circuitry (such as the memory management module 216 and the storage management module 218) may also perform a check to determine whether any of the plurality of manifest storages of the overlay system 202 includes any other manifest with an ID that matches the sixth ID 726. Since the first overlay node 606 does not have an overlay associated therewith, no other manifest has the ID that matches the sixth ID.

Notably, the manifest (the third manifest 718) of the first overlay node 606 includes a reference (such as an identifier that is common to the second manifest 716 and the third manifest 718, a link, a path, a storage location, or the like) to the second manifest 716 of the base node 302. Therefore, the re-formation of the executable node 602 includes re-creation of the first overlay node 606 prior to re-creation of the base node 302. Subsequently, the first overlay node 606 and the base node 302 are organized by associating the base node 302 with the first overlay node 606 to re-form the executable node 602.

In some embodiments, the first overlay node 606 may not be loaded in case it is not required for executing the operation associated with the one stimulus of the set of stimuli 236. The loaded executable node 602 and the first overlay node 606 may be unloaded in case they remain unused for a predefined time period, whereas one or more executable nodes that are used at least once during the predefined time period may remain loaded in the executable graph-based model 100. In some embodiments, the data and processing logic associated with a loaded executable node and/or overlay node may be transferred to a local memory of the overlay system 202 if the data and the processing logic remain unused for a first predefined period of time. Further, the data and the processing logic associated with the executable node/overlay node are transferred to an external storage from the local memory in case the executable node/overlay node remains unused for a second predefined period of time. The second predefined period of time is greater than the first predefined period of time. The term unloading refers to storing a state of a node with a current version of data and processing logic associated therewith at a storage location that is pointed by the corresponding manifest.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, the management and storage of manifests is managed by the controller module 206, the memory management module 216, the storage management module 218, a combination of these, or any other module of the overlay system 202. Also, all manifest states are stored together at a storage location (such as a manifest storage) that is known to the storage management module 218. Such centralized storage of the manifest states ensures that node states associated therewith are easily accessible.

It will be apparent to a person skilled in the art that although FIG. 7 illustrates only a single overlay node associated with a base node, in other embodiments, the executable node 602 may include additional or different overlay nodes (for example, the second overlay node 608). It will also be apparent to a person skilled in the art that only those overlay nodes that are required for responding to one stimulus of the set of stimuli 236 may be loaded.

In some embodiments, an executable node that includes the latch node 402 and one or more associated overlay nodes may have a composition and persistent storage similar to that of the executable node 602.

The overlay system 202 described in conjunction with FIGS. 1-7 is used to facilitate one or more operations associated with a plurality of latch nodes in the executable graph-based model 100. Various concepts and features associated with the latch nodes are described in detail later in the description.

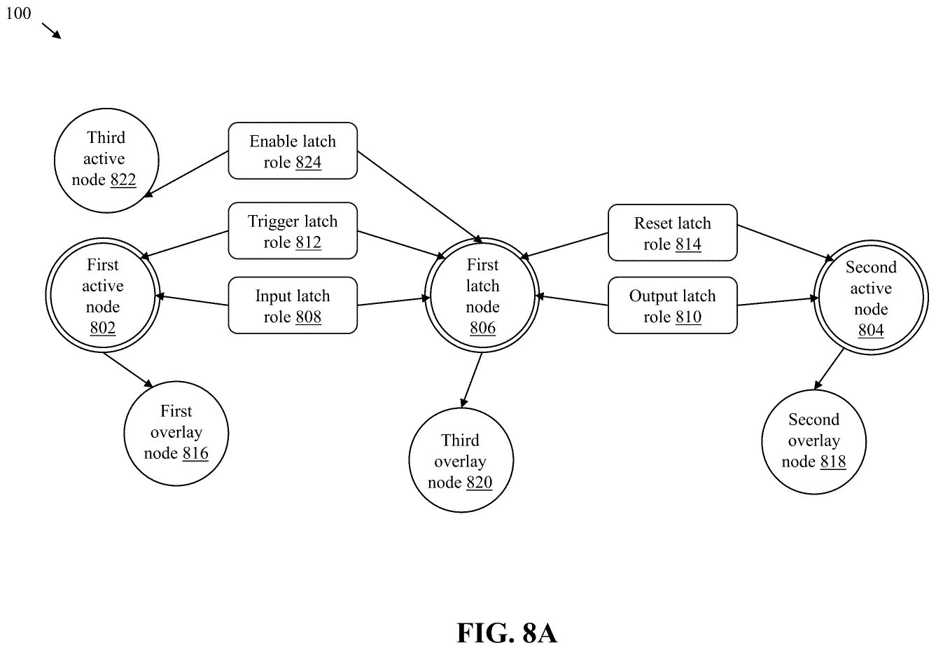

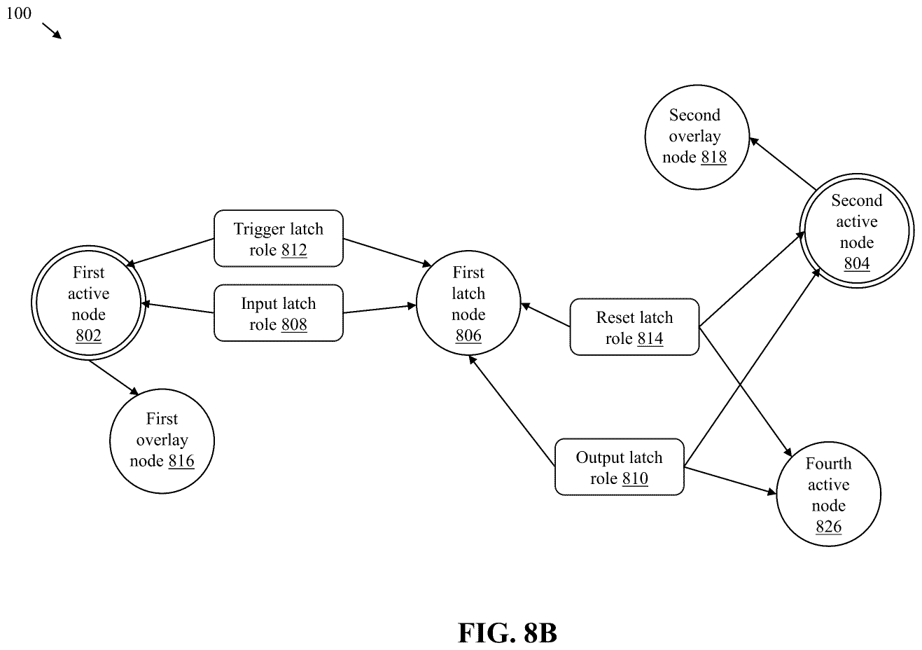

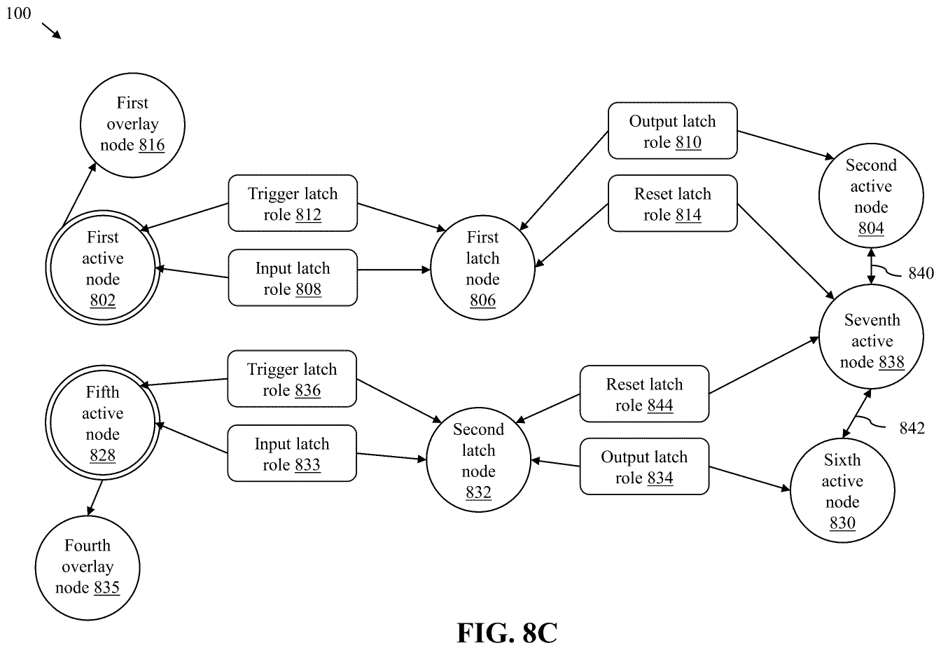

FIGS. 8A-8C, collectively, illustrate features of latch nodes in the executable graph-based model 100, consistent with disclosed embodiments of the present disclosure. Referring to FIG. 8A, shown is the executable graph-based model 100 that includes a plurality of active nodes. The plurality of active nodes may include a first active node 802 and a second active node 804. Each active node of the plurality of active nodes may be structurally and functionally similar to the active node 302.

Each active node of the plurality of active nodes may be one of a group consisting of a vertex node (for example, an active node with the vertex node-type 328), an edge node (for example, an active node with the edge node-type 330), a role node (for example, an active node with the role node-type 334), an overlay node (for example, an active node with the overlay node-type 332), an attribute vertex node, an attribute edge node, a property vertex node, or a property edge node. An attribute vertex node may be associated with an attribute of an active node and may have the structure and features of the active node 302 with the vertex node-type 328. Similarly, an attribute edge node may be associated with an attribute of an active node and may have the structure and features of the active node 302 with the edge node-type 330. Further, a property vertex node may be associated with a property of an active node and may have the structure and features of the active node 302 with the vertex node-type 328. Additionally, a property edge node may be associated with a property of an active node and may have the structure and features of the active node 302 with the edge node-type 330.

The executable graph-based model 100 may further include a first latch node 806. The first latch node 806 couples the first active node 802 and the second active node 804. Further, the first latch node 806 has a first plurality of latch roles associated therewith. Each latch role of the first plurality of latch roles may couple the first latch node 806 to an active node of the plurality of active nodes. Additionally, each latch role of the first plurality of latch roles may be configured to facilitate a predefined operation.

The first plurality of latch roles may include an input latch role 808 and an output latch role 810. The input latch role 808 may couple the first latch node 806 to the first active node 802, and the output latch role 810 may couple the first latch node 806 to the second active node 804.

The processing circuitry (for example, the controller module 206, the transaction module 208, the stimuli management module 212, or the like) may be configured to receive a first stimulus of the set of stimuli 236 associated with the overlay system 202. The processing circuitry (for example, the controller module 206, the transaction module 208, the stimuli management module 212, or the like) may be further configured to identify, based on the first stimulus, the first active node 802. Further, the processing circuitry (for example, the controller module 206, the transaction module 208, the stimuli management module 212, or the like) may be configured to execute an operation associated with the first stimulus based on the first active node 802. The execution of the operation associated with the first stimulus results in a first set of state changes in the first active node 802.

Each state change of the first set of state changes may correspond to a corresponding state change in a node element of the first active node 802. A node element of the first active node 802 may correspond to one of a unique ID, a version ID, a namespace, a name, a set of icons, a set of labels, a set of attributes, metadata, a node configuration, one or more node configuration strategies, and one or more node configuration extensions, of the first active node 802. In an example, the first set of state changes may include a first state change that corresponds to a change in an attribute of the first active node 802.

The processing circuitry (for example, the controller module 206, the transaction module 208, the stimuli management module 212, the latch management module 222, or the like) may be further configured to detect, based on the first latch node 806, the first set of state changes in the first active node 802. The first set of state changes detected in the first active node 802 is to be transferred to the second active node 804.

In some embodiments, the first set of changes may be periodic. That is to say, the first set of changes may occur periodically in the first active node 802. In other words, the processing circuitry may periodically receive the first stimulus that is responsible for the first set of state changes in the first active node 802.

The first plurality of latch roles further includes a trigger latch role 812, where the first latch node 806 is coupled to the first active node 802 by way of the trigger latch role 812. Further, the processing circuitry (for example, the controller module 206, the transaction module 208, the stimuli management module 212, the latch management module 222, or the like) may be configured to monitor the first active node 802 using the trigger latch role 812. In other words, the trigger latch role 812 facilitates monitoring of the first active node 802. Further, the processing circuitry detects the first set of state changes based on the monitoring of the first active node 802 using the trigger latch role 812. Thus, the predefined operation associated with the trigger latch role 812 corresponds to a facilitation of monitoring of the first active node 802.

The processing circuitry (for example, the controller module 206, the transaction module 208, the stimuli management module 212, the latch management module 222, or the like) may be further configured to receive a reset signal associated with the first latch node 806. The reset signal may indicate an availability of the second active node 804 to receive the first set of state changes. Further, the processing circuitry (for example, the controller module 206, the transaction module 208, the stimuli management module 212, the latch management module 222, or the like) may be configured to transfer the first set of state changes to the second active node 804 based on the reception of the reset signal. Additionally, the processing circuitry transfers the first set of state changes from the first active node 802 to the second active node 804 using the input latch role 808 and the output latch role 810. Thus, the predefined operation associated with the input latch role 808 and the output latch role 810 corresponds to a facilitation of the transfer of the first set of state changes from the first active node 802 to the second active node 804.

In some embodiments, to transfer the first set of state changes from the first active node 802 to the second active node 804, the processing circuitry may fetch the first set of state changes from the first active node 802 using the input latch role 808, and send the fetched first set of state changes to the second active node 804 using the output latch role 810.

The processing circuitry (for example, the controller module 206, the transaction module 208, the stimuli management module 212, the latch management module 222, or the like) may be further configured to generate, using the trigger latch role 812, a trigger signal based on the detection of the first set of state changes. The transfer of the first set of state changes is further based on the trigger signal. In other words, the first set of state changes is transferred from the first active node 802 to the second active node 804 based on the generation of the trigger signal and the reception of the reset signal. Additionally, the trigger signal is generated based on the first set of state changes in the first active node 802 and the reset signal is received based on the availability of the second active node 804 to receive the first set of state changes. The trigger signal may be one of a group consisting of a data signal, a timing signal, or a clock signal.

In some embodiments, the processing circuitry may transfer the first set of state changes to the second active node 804 based on a signal potential of the trigger signal being greater than a potential threshold. In such embodiments, the trigger signal may be one of a group consisting of an excitation signal or an inhibition signal. Further, the excitation signal is a positive signal and the inhibition signal is a negative signal.

The first plurality of latch roles may further include a reset latch role 814. The first latch node 806 is coupled to the second active node 804 by way of the reset latch role 814. The processing circuitry (for example, the controller module 206, the transaction module 208, the latch management module 222, or the like) may be further configured to monitor, using the reset latch role 814, the second active node 804. In other words, the reset latch role 814 facilitates the monitoring of the second active node 804 to determine the availability of the second active node 804 to receive the first set of state changes. Further, the processing circuitry receives the reset signal based on the monitoring of the second active node 804 using the reset latch role 814. That is to say, the processing circuitry receives the reset signal when the second active node 804 is available to receive the first set of state changes.

The processing circuitry (for example, the controller module 206, the transaction module 208, the stimuli management module 212, the latch management module 222, or the like) may be further configured to receive a second stimulus of the set of stimuli 236. The second stimulus may be received after the reception of the first stimulus. Further, the processing circuitry (for example, the controller module 206, the transaction module 208, the stimuli management module 212, the latch management module 222, or the like) may be configured to identify, based on the second stimulus, the second active node 804. The processing circuitry may be further configured to execute an operation associated with the second stimulus based on the second active node 804. The reset signal is received based on the execution of the operation associated with the second stimulus. That is to say, the availability of the second active node 804 to receive the first set of state changes is based on the execution of the operation associated with the second stimulus. In other words, the second active node 804 is available to receive the first set of state changes after the execution of the operation associated with the second stimulus.

To summarize, the first latch node 806 facilitates halting of the transfer of the first set of state changes from the first active node 802 to the second active node 804 until the second active node 804 is available to receive the first set of state changes, thereby mitigating immediate transfer of the first set of state changes from the first active node 802 to the second active node 804 upon the first set of state changes in the first active node 802.

In some embodiments, the executable graph-based model 100 may further include a plurality of overlay nodes. The processing circuitry may be further configured to identify, from the plurality of overlay nodes, a first set of overlay nodes that is associated with the first active node 802. The first set of overlay nodes may be configured to extend functionality of the first active node 802. The operation associated with the first stimulus is executed further based on the first set of overlay nodes. For the sake of ongoing discussion, it is assumed that the first set of overlay nodes includes a first overlay node 816, thus the operation associated with the first stimulus is executed further based on the first overlay node 816.

The processing circuitry (for example, the controller module 206, the transaction module 208, the stimuli management module 212, the latch management module 222, or the like) may be further configured to receive a third stimulus of the set of stimuli 236. The third stimulus may be received after the transfer of the first set of state changes from the first active node 802 to the second active node 804. The transfer of the first set of state changes results in one or more state changes to one or more node elements of the second active node 804. In an example, when the first set of state changes in the first active node 802 corresponds to a state change of the attribute of the first active node 802, the transfer of the first set of state changes to the second active node 804 results in a state change of a corresponding attribute of the second active node 804.

The processing circuitry (for example, the controller module 206, the transaction module 208, the stimuli management module 212, the latch management module 222, or the like) may be configured to identify the second active node 804 based on the third stimulus. The processing circuitry (for example, the controller module 206, the transaction module 208, the stimuli management module 212, the latch management module 222, or the like) may be further configured to execute an operation associated with the third stimulus based on the second active node 804 with the first set of state changes. The execution of the operation associated with the third stimulus may result in generation of an outcome (for example, the outcome 240).

In some embodiments, the processing circuitry may be further configured to identify, from the plurality of overlay nodes, a second set of overlay nodes that is associated with the second active node 804. The second set of overlay nodes may be configured to extend functionality of the second active node 804. The operation associated with the third stimulus is executed further based on the second set of overlay nodes. For the sake of ongoing discussion, it is assumed that the second set of overlay nodes includes a second overlay node 818, thus the operation associated with the third stimulus is executed further based on the second overlay node 818.

In some embodiments, the processing circuitry may be further configured to identify, from the plurality of overlay nodes, a third set of overlay nodes that is associated with the first latch node 806. The third set of overlay nodes may be configured to extend functionality of the first latch node 806. The processing circuitry is further configured to execute the third set of overlay nodes on the first latch node 806 based on the reception of the reset signal. For the sake of ongoing discussion, it is assumed that the third set of overlay nodes includes a third overlay node 820, thus the third overlay node 820 is executed on the first latch node 806 based on the reception of the reset signal. The first set of state changes may be modified based on the execution of the third set of overlay nodes to obtain a modified first set of state changes. Thus, the transfer of the first set of state changes corresponds to a transfer of the modified first set of state changes.

In some embodiments, the processing circuitry may be further configured to receive an enable signal associated with the first latch node 806. The transfer of the first set of state changes may be further based on the enable signal. The enable signal may be responsible for enabling the transfer of the first set of state changes. That is to say, the first set of state changes is transferred from the first active node 802 to the second active node 804 only after the reception of the enable signal despite the reception of the reset signal and the generation of the trigger signal. The plurality of active nodes may further include a third active node 822. The third active node 822 may be coupled to the first latch node 806. Additionally, the first plurality of latch roles may further include an enable latch role 824, where the enable latch role 824 may couple the first latch node 806 to the third active node 822. The processing circuitry may receive the enable signal based on the third active node 822 using the enable latch role 824.

In some embodiments, prior to the execution of the operation associated with the first stimulus, if the first active node 802, the second active node 804, and the first latch node 806 are not present in the executable graph-based model 100, the processing circuitry (for example, the controller module 206, the transaction module 208, the latch management module 222, or the like) may load the first active node 802, the second active node 804, and the first latch node 806 into the executable graph-based model 100. The first active node 802, the second active node 804, and the first latch node 806 may be loaded based on the reception of the first stimulus. Further, upon execution of the operation associated with the third stimulus, the processing circuitry (for example, the controller module 206, the transaction module 208, the latch management module 222, or the like) may unload the first active node 802, the second active node 804, and the first latch node 806 from the executable graph-based model 100.

Although the executable graph-based model 100 illustrated in FIG. 8A is shown to include one latch node, the scope of the present disclosure is not limited to it. In further embodiments, the executable graph-based model 100 may include a plurality of latch nodes with each latch node coupling at least two active nodes of the plurality of active nodes where the plurality of active nodes may include more than three active nodes.

Although it is described that the first latch node 806 couples the first active node 802 to the second active node 804, the scope of the present disclosure is not limited to it. In additional embodiments, the first latch node 806 may couple the first active node 802 to more than one active node.

In some embodiments, each node illustrated in FIG. 8A may correspond to a run-time node (for example, the run-time node 502) that includes a node template and a node instance, where the node template corresponds to a predefined node structure, whereas the node instance corresponds to an implementation of the node template.

Having discussed a few features of the first latch node 806, the description now moves towards discussion of additional features associated with the first latch node 806.

Referring to FIG. 8B, the plurality of active nodes in the executable graph-based model 100 is further shown to include a fourth active node 826. The first latch node 806 may further couple the first active node 802 to the fourth active node 826. The reset latch role 814 and the output latch role 810 may further facilitate the coupling of the fourth active node 826 to the first active node 802. In such a scenario, the processing circuitry (for example, the controller module 206, the transaction module 208, the stimuli management module 212, the latch management module 222, or the like) may be further configured to detect, based on the first latch node 806, a second set of state changes in the first active node 802. Particularly, the trigger latch role 812 may facilitate the detection of the second set of state changes in the first active node 802. Additionally, the second set of state changes detected in the first active node 802 is to be transferred to the fourth active node 826.

The second set of state changes may be a result of the execution of the operation associated with the first stimulus. After the detection of the second set of state changes, the processing circuitry (for example, the controller module 206, the transaction module 208, the stimuli management module 212, the latch management module 222, or the like) may be further configured to transfer the second set of state changes to the fourth active node 826 based on the reception of the reset signal. The second set of state changes is transferred to the fourth active node 826 by using the input latch role 808 and the output latch role 810.

In some embodiments, the first set of state changes may include the second set of state changes. In some additional embodiments, the second set of state changes may be different from the first set of state changes.

The reset signal is further indicative of an availability of the fourth active node 826 to receive the second set of state changes. That is to say, the processing circuitry (for example, the controller module 206, the transaction module 208, the stimuli management module 212, the latch management module 222, or the like) receives the reset signal by using the reset latch role 814 when the fourth active node 826 is available to receive the second set of state changes and the second active node 804 is available to receive the first set of state changes.

Although it is described that the second set of state changes may be the result of the execution of the operation associated with the first stimulus, the scope of the present disclosure is not limited to it. In some embodiments, the second set of state changes may be a result of an execution of an operation associated with a fourth stimulus of the set of stimuli 236. In such embodiments, the processing circuitry may be configured to receive the fourth stimulus and execute the operation associated with the fourth stimulus.

Although it is described that the reset signal is indicative of the availability of the second active node 804 to receive the first set of state changes and the availability of the fourth active node 826 to receive the second set of state changes, the scope of the present disclosure is not limited to it. In some embodiments, the reset signal may be solely indicative of the availability of the fourth active node 826 to receive the second set of state changes.

Referring to FIG. 8C, the plurality of active nodes in the executable graph-based model 100 is further shown to include a fifth active node 828 and a sixth active node 830. Additionally, the executable graph-based model 100 is further shown to include a second latch node 832. The second latch node 832 may couple the fifth active node 828 and the sixth active node 830. Further, the second latch node 832 may have a second plurality of latch roles associated therewith. The second plurality of latch roles may include an input latch role 833 and an output latch role 834. The second latch node 832 couples the fifth active node 828 and the sixth active node 830 using the input latch role 833 and the output latch role 834.

The processing circuitry (for example, the controller module 206, the transaction module 208, the stimuli management module 212, or the like) may be further configured to receive a fifth stimulus of the set of stimuli 236. For the sake of ongoing discussion, it is assumed that the fifth stimulus is received after the reception of the first stimulus. The processing circuitry (for example, the controller module 206, the transaction module 208, the stimuli management module 212, or the like) may be further configured to identify the fifth active node 828 based on the fifth stimulus and execute an operation associated with the fifth stimulus based on the fifth active node 828. The execution of the operation associated with the fifth stimulus results in a third set of state changes in the fifth active node 828. The third set of state changes may be associated with a node element of the fifth active node 828.

In some embodiments, the plurality of overlay nodes may further include a fourth overlay node 835 that may be configured to extend functionality of the fifth active node 828. In such embodiments, the processing circuitry may be further configured to identify the fourth overlay node 835 that is associated with the fifth active node 828 upon the identification of the fifth active node 828. Additionally, the operation associated with the fifth stimulus is executed further based on the fourth overlay node 835.

The processing circuitry (for example, the controller module 206, the transaction module 208, the stimuli management module 212, the latch management module 222, or the like) may be further configured to detect the third set of state changes in the fifth active node 828 based on the second latch node 832. The second plurality of latch roles may further include a trigger latch role 836, where the trigger latch role 836 may couple the fifth active node 828 to the second latch node 832. Further, the processing circuitry may detect the third set of state changes in the fifth active node 828 using the trigger latch role 836. In other words, the trigger latch role 836 facilitates the detection of the third set of state changes in the fifth active node 828. Further, the third set of state changes detected in the fifth active node 828 is to be transferred to the sixth active node 830.

After the detection of the third set of state changes, the processing circuitry (for example, the controller module 206, the transaction module 208, the stimuli management module 212, the latch management module 222, or the like) may be further configured to transfer the third set of state changes to the sixth active node 830 based on the reception of the reset signal. The reset signal may further indicate an availability of the sixth active node 830 to receive the third set of state changes. The first set of state changes and the third set of state changes are synchronously transferred to the second active node 804 and the sixth active node 830, respectively, based on the reset signal.

As shown in FIG. 8C, the plurality of active nodes is shown to further include a seventh active node 838. The seventh active node 838 may be coupled to the second active node 804 and the sixth active node 830. The seventh active node 838 may be coupled to the second active node 804 by way of a role 840. Similarly, the seventh active node 838 may be coupled to the sixth active node 830 by way of a role 842. The seventh active node 838 may be indicative of the availability of the second active node 804 and the sixth active node 830 to receive the first set of state changes and the third set of state changes, respectively. Further, the reset latch role 814 is shown to couple the first latch node 806 to the seventh active node 838. In other words, the reset latch role 814 is coupled to the second active node 804 by way of the seventh active node 838.

Further, the processing circuitry (for example, the controller module 206, the transaction module 208, the stimuli management module 212, the latch management module 222, or the like) may be configured to monitor the seventh active node 838 using the reset latch role 814 and a reset latch role 844 of the second plurality of latch roles. In other words, the processing circuitry monitors the second active node 804 further based on the seventh active node 838. Similarly, the processing circuitry monitors the sixth active node 830 based on the seventh active node 838.

The processing circuitry may receive the reset signal based on the monitoring of the seventh active node 838. Particularly, the processing circuitry may receive the reset signal when the monitoring of the seventh active node 838 results in a determination that the second active node 804 and the sixth active node 830 are available to receive the first set of state changes and the third set of state changes, respectively.

Having described the features of the latch nodes, the description now moves towards a use case scenario associated with the overlay system 202 described herein.

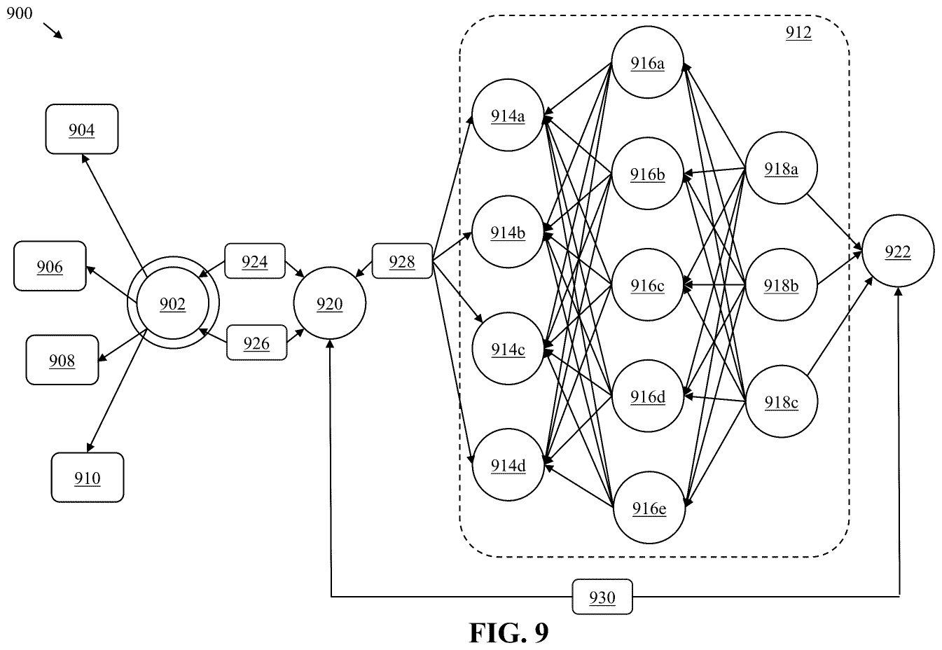

FIG. 9 is a schematic diagram that illustrates an implementation of latch nodes in an executable graph-based model, consistent with disclosed embodiments of the present disclosure. Referring to FIG. 9, an executable graph-based model 900 is illustrated. The executable graph-based model 900 is shown to include a person node 902. The person node 902 may correspond to an active node with the vertex node-type 328. Further, the person node 902 may be associated with a gender attribute 904, an age attribute 906, a location attribute 908, and an income attribute 910. The gender attribute 904 may be indicative of a gender of a first person represented by the person node 902. Further, the age attribute 906 may be indicative of an age of the first person and the location attribute 908 may be indicative of a location of the first person. Additionally, the income attribute 910 may be indicative of the income of the first person.

A political inclination of a person is to be determined based on a gender, an age, a location, and an income of the person. Thus, the executable graph-based model 900 is further shown to include a political inclination neural network 912. The political inclination neural network 912 is composed of a set of input nodes 914a-914d, a set of hidden nodes 916a-916e, and a set of output nodes 918a-918c. Each input node of the set of input nodes 914a-914d is coupled to each hidden node of the set of hidden nodes 916a-916e. Further, each hidden node of the set of hidden nodes 916a-916e is coupled to each output node of the set of output nodes 918a-918c. Each node of the political inclination neural network 912 may correspond to an active node with the edge node-type 330.

The set of input nodes 914a-914d may include a gender input node 914a, an age input node 914b, a location input node 914c, and an income input node 914d. Further, the set of hidden nodes 916a-916e may include hidden nodes 916a-916e. Further, the set of output nodes 918a-918c may include a first output node 918a, a second output node 918b, and a third output node 918c. The first output node 918a may represent a probability of the political inclination of a person being ‘Conservative’. Further, the second output node 918b may represent a probability of the political inclination of a person being ‘Liberal’ and the third output node 918c may represent a probability of the political inclination of a person being ‘Moderate’.

The executable graph-based model 900 is further shown to include an input latch node 920 that couples the person node 902 to each input node of the set of input nodes 914a-914d. The executable graph-based model 900 further includes a political inclination node 922 that represents the political inclination as one of ‘Conservative’, ‘Liberal’, and ‘Moderate’. The political inclination node 922 may correspond to an active node with the vertex node-type 328. The input latch node 920 has an input latch role 924, a trigger latch role 926, an output latch role 928, and a reset latch role 930 associated therewith that facilitate the coupling of the person node 902 to the set of input nodes 914a-914d and the political inclination node 922.

In operation, for the sake of ongoing discussion, it is assumed that the processing circuitry is executing an operation using the set of input nodes 914a-914d, the set of hidden nodes 916a-916e, and the set of output nodes 918a-918c to determine the political inclination of the first person. During the execution of the operation, the gender input node 914a may be indicative of the gender of the first person, the age input node 914b may be indicative of the age of the first person, the location input node 914c may be indicative of the location of the first person, and the income input node 914d may be indicative of the income of the first person.

The processing circuitry may further receive a first stimulus of the set of stimuli 236 during the execution of the operation to determine the political inclination of the first person. The first stimulus may indicate the processing circuitry to update the person node 902 based on a gender, an age, a location, and an income of a second person. Thus, the processing circuitry may execute an operation associated with the first stimulus that results in an update of the gender attribute 904, the age attribute 906, the location attribute 908, and the income attribute 910. The update of the gender attribute 904, the age attribute 906, the location attribute 908, and the income attribute 910 correspond to a set of state changes in the person node 902.

The processing circuitry may monitor the person node 902 using the trigger latch role 926. Further, the processing circuitry may detect the set of state changes in the person node 902 based on the monitoring of the person node 902. Further, the processing circuitry monitors the political inclination node 922 using the reset latch role 930. The processing circuitry may simultaneously perform the above-described operations while executing the operation to determine the political inclination of the first person. The political inclination node 922 is monitored to determine whether the political inclination is updated in the political inclination node 922 based on the execution of the operation to determine the political inclination of the first person. That is to say, the completion of the execution of the operation to determine the political inclination of the first person results in the update of the political inclination node 922.

The processing circuitry receives a reset signal based on the monitoring of the political inclination node 922. In other words, the processing circuitry receives the reset signal based on the completion of the execution of the operation to determine the political inclination of the first person. The reset signal indicates that the set of input nodes 914a-914d is available to receive the set of state changes. Thus, the processing circuitry transfers the set of state changes from the person node 902 to the set of input nodes 914a-914d.

A state of each of the set of input nodes 914a-914d is updated after the determination of the political inclination of the first person. In other words, after the transfer of the set of state changes, the gender input node 914a may be indicative of the gender of the second person, the age input node 914b may be indicative of the age of the second person, the location input node 914c may be indicative of the location of the second person, and the income input node 914d may be indicative of the income of the second person.

To summarize, the input latch node 920 halts the transfer of the set of state changes from the person node 902 to the set of input nodes 914a-914d until the determination of the political inclination of the first person. As a result, a correlation between inputs (for example, the gender, the age, the location, and the income, of the first person) and an output (for example, the political inclination of the first person) is obtained in the described executable graph-based model 900.

Having discussed various concepts, operations, and usage associated with the overlay system 202, the description now moves towards a computing system for implementing the overlay system 202 that incorporates latch nodes.

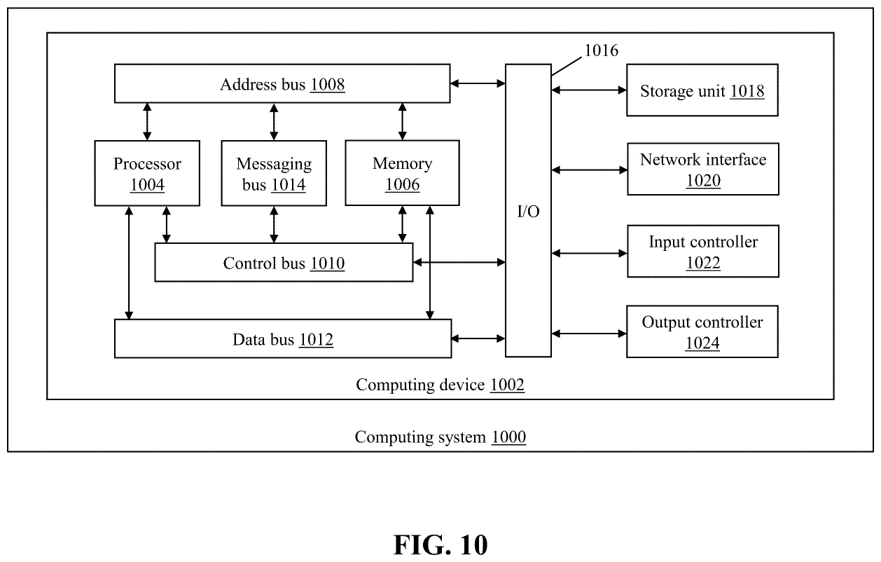

FIG. 10 shows an example computing system 1000 for carrying out methods of the present disclosure, consistent with disclosed embodiments of the present disclosure. Specifically, FIG. 10 shows a block diagram of an embodiment of the computing system 1000 according to example embodiments of the present disclosure.

The computing system 1000 may be configured to perform any of the operations disclosed herein, such as for example, any of the operations discussed with reference to the functional modules described in relation to FIG. 2. The computing system 1000 may be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 1000 is a distributed system configured to function using multiple computing machines interconnected via a data network or bus system.

The computing system 1000 includes computing devices (such as a computing device 1002). The computing device 1002 includes one or more processors (such as a processor 1004) and a memory 1006. The processor 1004 may be any general-purpose processor(s) configured to execute a set of instructions. For example, the processor 1004 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 1004 may be multiple processing units, a single processing core, multiple processing cores, special purpose processing cores, co-processors, or any combination thereof. The processor 1004 may be communicatively coupled to the memory 1006 via an address bus 1008, a control bus 1010, a data bus 1012, and a messaging bus 1014.

The memory 1006 may include non-volatile memories such as a read-only memory (ROM), a programable read-only memory (PROM), an erasable programmable read-only memory (EPROM), a flash memory, or any other device capable of storing program instructions or data with or without applied power. The memory 1006 may also include volatile memories, such as a random-access memory (RAM), a static random-access memory (SRAM), a dynamic random-access memory (DRAM), and a synchronous dynamic random-access memory (SDRAM). The memory 1006 may include single or multiple memory modules. While the memory 1006 is depicted as part of the computing device 1002, a person skilled in the art will recognize that the memory 1006 can be separate from the computing device 1002.

The memory 1006 may store information that can be accessed by the processor 1004. For instance, the memory 1006 (e.g., one or more non-transitory computer-readable storage mediums, memory devices) may include computer-readable instructions (not shown) that can be executed by the processor 1004. The computer-readable instructions may be software written in any suitable programming language or may be implemented in hardware. Additionally, or alternatively, the computer-readable instructions may be executed in logically and/or virtually separate threads on the processor 1004. For example, the memory 1006 may store instructions (not shown) that when executed by the processor 1004 cause the processor 1004 to perform operations such as any of the operations and functions for which the computing system 1000 is configured, as described herein. Additionally, or alternatively, the memory 1006 may store data (not shown) that can be obtained, received, accessed, written, manipulated, created, and/or stored. The data can include, for instance, the data and/or information described herein in relation to FIGS. 1-9. In some implementations, the computing device 1002 may obtain from and/or store data in one or more memory device(s) that are remote from the computing system 1000.

The computing device 1002 may further include an input/output (I/O) interface 1016 communicatively coupled to the address bus 1008, the control bus 1010, and the data bus 1012. The data bus 1012 and messaging bus 1014 may include a plurality of tunnels that may support parallel execution of messages by the overlay system 202. The I/O interface 1016 is configured to couple to one or more external devices (e.g., to receive and send data from/to one or more external devices). Such external devices, along with the various internal devices, may also be known as peripheral devices. The I/O interface 1016 may include both electrical and physical connections for operably coupling the various peripheral devices to the computing device 1002. The I/O interface 1016 may be configured to communicate data, addresses, and control signals between the peripheral devices and the computing device 1002. The I/O interface 1016 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 1016 is configured to implement only one interface or bus technology. Alternatively, the I/O interface 1016 is configured to implement multiple interfaces or bus technologies. The I/O interface 1016 may include one or more buffers for buffering transmissions between one or more external devices, internal devices, the computing device 1002, or the processor 1004. The I/O interface 1016 may couple the computing device 1002 to various input devices, including mice, touch screens, scanners, biometric readers, electronic digitizers, sensors, receivers, touchpads, trackballs, cameras, microphones, keyboards, any other pointing devices, or any combinations thereof. The I/O interface 1016 may couple the computing device 1002 to various output devices, including video displays, speakers, printers, projectors, tactile feedback devices, automation control, robotic components, actuators, motors, fans, solenoids, valves, pumps, transmitters, signal emitters, lights, and so forth.

The computing system 1000 may further include a storage unit 1018, a network interface 1020, an input controller 1022, and an output controller 1024. The storage unit 1018, the network interface 1020, the input controller 1022, and the output controller 1024 are communicatively coupled to the central control unit (e.g., the memory 1006, the address bus 1008, the control bus 1010, and the data bus 1012) via the I/O interface 1016. The network interface 1020 communicatively couples the computing system 1000 to one or more networks such as wide area networks (WAN), local area networks (LAN), intranets, the Internet, wireless access networks, wired networks, mobile networks, telephone networks, optical networks, or combinations thereof. The network interface 1020 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 1018 is a computer-readable medium, preferably a non-transitory computer-readable medium, comprising one or more programs, the one or more programs comprising instructions which when executed by the processor 1004 cause the computing system 1000 to perform the method steps of the present disclosure. Alternatively, the storage unit 1018 is a transitory computer-readable medium. The storage unit 1018 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 1018 stores one or more operating systems, application programs, program modules, data, or any other information. The storage unit 1018 is part of the computing device 1002. Alternatively, the storage unit 1018 is part of one or more other computing machines that are in communication with the computing device 1002, such as servers, database servers, cloud storage, network attached storage, and so forth.

The input controller 1022 may include suitable logic, circuitry, interfaces, and/or code, executable by the circuitry, that may be configured to control one or more input devices that may be configured to receive an input (e.g., the first stimulus of the set of stimuli 236) for the overlay system 202. The output controller 1024 may include suitable logic, circuitry, interfaces, and/or code, executable by the circuitry, that may be configured to control one or more output devices that may be configured to render/output the outcome (e.g., the outcome 240) of the operation executed to process the received input (e.g., the first stimulus of the set of stimuli 236).

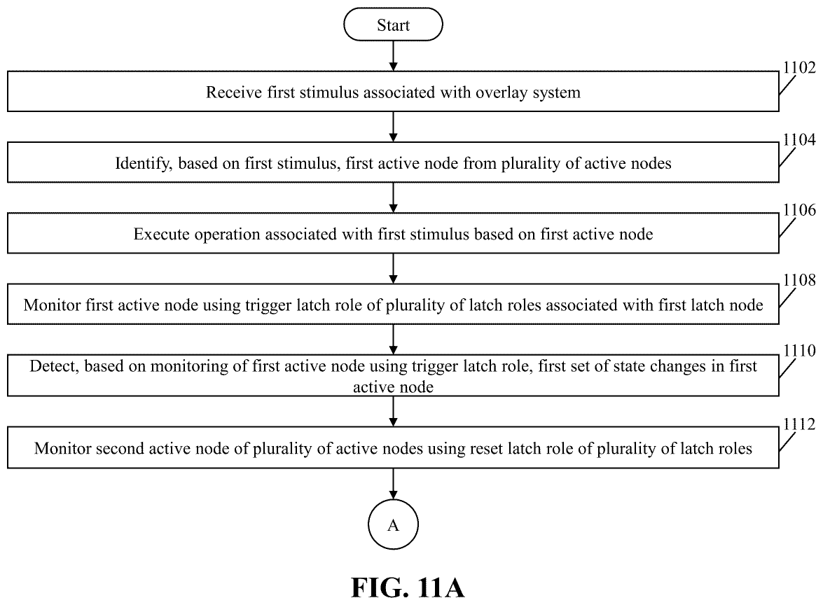

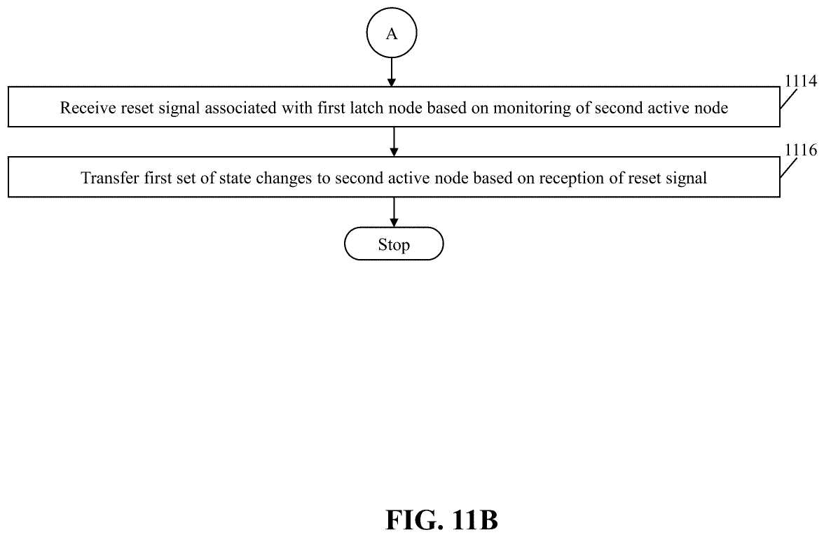

FIGS. 11A and 11B, collectively, illustrate a flowchart 1100 of a method for processing a stimulus using a latch node (for example, the first latch node 806), consistent with disclosed embodiments of the present disclosure. Referring to FIG. 11A, at 1102, a first stimulus is received. The processing circuitry (such as the controller module 206 and the stimuli management module 212) receives the stimulus associated with the overlay system 202. The stimulus is indicative of an operation to be performed using a first active node.

At 1104, the first active node is identified from the plurality of active nodes of the executable graph-based model 100. The processing circuitry (such as the controller module 206, the context module 210, and the stimuli management module 212) may identify the first active node from the plurality of active nodes.

At 1106, an operation associated with the first stimulus is executed based on the first active node. The processing circuitry (such as the controller module 206, the transaction module 208, the context module 210, and the stimuli management module 212) may execute the operation associated with the first stimulus based on the first active node. The execution of the operation associated with the first stimulus results in a first set of state changes in the first active node. Each state change of the first set of state changes corresponds to a state change of a node element of the first active node.

At 1108, the first active node is monitored using a trigger latch role of a plurality of latch roles associated with a first latch node. The first latch node couples the first active node to a second active node of the plurality of active nodes. Further, the trigger latch role couples the first latch node to the first active node. Additionally, the first set of state changes is to be transferred to the second active node. The processing circuitry (such as the controller module 206, the transaction module 208, and the latch management module 222) may monitor the first active node using the trigger latch role.

At 1110, the first set of state changes is detected in the first active node based on the monitoring of the first active node using the trigger latch role. The processing circuitry (such as the controller module 206, the transaction module 208, and the latch management module 222) may detect the first set of state changes in the first active node based on the monitoring of the first active node using the trigger latch role.

At 1112, the second active node of the plurality of active nodes is monitored using a reset latch role of the plurality of latch roles associated with the first latch node. The processing circuitry (such as the controller module 206, the transaction module 208, and the latch management module 222) may monitor the second active node using the reset latch role.

Referring to FIG. 11B, at 1114, a reset signal associated with the first latch node is received based on the monitoring of the second active node. The reset signal is indicative of an availability of the second active node to receive the first set of state changes. The processing circuitry (such as the controller module 206, the transaction module 208, the context module 210, the stimuli management module 212, and the latch management module 222) may receive the reset signal associated with the first latch node based on the monitoring of the second active node.

At 1116, the first set of state changes is transferred to the second active node based on the reception of the reset signal. The processing circuitry (such as the controller module 206, the transaction module 208, the context module 210, the stimuli management module 212, and the latch management module 222) may transfer the first set of state changes to the second active node based on the reception of the reset signal.

The disclosed embodiments encompass numerous advantages including a simple and user-friendly implementation of the executable graph-based model 100 that may be in turn used to implement various complex and advanced applications. Further, the disclosed systems and methods allow for facilitation of latch nodes in the executable graph-based model 100. A latch node couples two or more active nodes in the executable graph-based model. Further, the latch node facilitates a transfer of state changes from one active node to another active node only when the other active node is available to receive the state changes. That is to say, the latch node facilitated monitoring of the other active node to determine the availability of the other active node to receive the state changes. As a result, loss of correlation between inputs and outputs associated with an operation is mitigated. Additionally, the latch nodes in the executable graph-based model 100 may facilitate synchronized transfer of state changes between active nodes in the executable graph-based model 100. Application areas of the systems and methods disclosed herein are fintech platforms, social media platforms, gaming platforms, research and analytics platforms, robotics, or the like.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems, and methods for facilitating a plurality of latch nodes in the executable graph-based model. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. An overlay system, comprising:
a storage element configured to store an executable graph-based model that includes a plurality of active nodes and a plurality of latch nodes, with each latch node coupling at least two active nodes; and
processing circuitry that is coupled to the storage element, and configured to:
   detect, based on a first latch node of the plurality of latch nodes, a first set of state changes in a first active node of the plurality of active nodes, wherein the first latch node couples the first active node and a second active node of the plurality of active nodes, and wherein the first set of state changes detected in the first active node is to be transferred to the second active node;
   receive a reset signal associated with the first latch node, the reset signal indicating an availability of the second active node to receive the first set of state changes; and
   transfer the first set of state changes to the second active node based on the reception of the reset signal.
2. The overlay system of 1, wherein the processing circuitry is further configured to:
receive a first stimulus associated with the overlay system;
identify, based on the first stimulus, the first active node; and
execute an operation associated with the first stimulus based on the first active node, wherein the execution of the operation associated with the first stimulus results in the first set of state changes in the first active node.
3. The overlay system of 2,
wherein the executable graph-based model further includes a plurality of overlay nodes,
wherein the processing circuitry is further configured to identify, from the plurality of overlay nodes, a first set of overlay nodes that is associated with the first active node,
wherein the first set of overlay nodes is configured to extend functionality of the first active node, and
wherein the operation associated with the first stimulus is executed further based on the first set of overlay nodes.
4. The overlay system of 1,
wherein the first latch node has a plurality of latch roles associated therewith,
wherein an input latch role of the plurality of latch roles couples the first latch node to the first active node, and
wherein an output latch role of the plurality of latch roles couples the first latch node to the second active node.
5. The overlay system of 4, wherein the processing circuitry transfers the first set of state changes from the first active node to the second active node using the input latch role and the output latch role.
6. The overlay system of 4,
wherein the plurality of latch roles includes a trigger latch role,
wherein the first latch node is coupled to the first active node by way of the trigger latch role,
wherein the processing circuitry is further configured to monitor, using the trigger latch role, the first active node, and
wherein the processing circuitry detects the first set of state changes based on the monitoring of the first active node using the trigger latch role.
7. The overlay system of 6,
wherein the processing circuitry is further configured to generate, using the trigger latch role, a trigger signal based on the detection of the first set of state changes, and
wherein the transfer of the first set of state changes is further based on the trigger signal.
8. The overlay system of 7, wherein the trigger signal is one of a group consisting of a data signal, a timing signal, or a clock signal.
9. The overlay system of 7, wherein the processing circuitry transfers the first set of state changes to the second active node based on a signal potential of the trigger signal being greater than a potential threshold.
10. The overlay system of 9,
wherein the trigger signal is one of a group consisting of an excitation signal or an inhibition signal, and
wherein the excitation signal is a positive signal and the inhibition signal is a negative signal.
11. The overlay system of 4,
wherein the plurality of latch roles includes a reset latch role,
wherein the first latch node is coupled to the second active node by way of the reset latch role,
wherein the processing circuitry is further configured to monitor, using the reset latch role, the second active node, and
wherein the processing circuitry receives the reset signal based on the monitoring of the second active node using the reset latch role.
12. The overlay system of 11, wherein the processing circuitry is further configured to:
receive a second stimulus associated with the overlay system;
identify, based on the second stimulus, the second active node; and
execute an operation associated with the second stimulus based on the second active node, wherein the reset signal is received based on the execution of the operation associated with the second stimulus.
13. The overlay system of 11, wherein the reset latch role is coupled to the second active node by way of a third active node of the plurality of active nodes, and wherein the processing circuitry monitors the second active node further based on the third active node.
14. The overlay system of 1,
wherein the processing circuitry is further configured to receive an enable signal associated with the first latch node, and
wherein the transfer of the first set of state changes is further based on the enable signal.
15. The overlay system of 1, wherein the processing circuitry is further configured to:
receive a third stimulus associated with the overlay system, wherein the third stimulus is received after the transfer of the first set of state changes to the second active node;
identify, based on the third stimulus, the second active node; and
execute an operation associated with the third stimulus based on the second active node with the first set of state changes.
16. The overlay system of 15,
wherein the executable graph-based model further includes a plurality of overlay nodes,
wherein the processing circuitry is further configured to identify, from the plurality of overlay nodes, a second set of overlay nodes that is associated with the second active node,
wherein the second set of overlay nodes is configured to extend functionality of the second active node, and
wherein the operation associated with the third stimulus is executed further based on the second set of overlay nodes.
17. The overlay system of 1, wherein the processing circuitry is further configured to:
detect a second set of state changes in a fourth active node of the plurality of active nodes based on a second latch node of the plurality of latch nodes, wherein the second latch node couples the fourth active node and a fifth active node of the plurality of active nodes, and wherein the second set of state changes detected in the fourth active node is to be transferred to the fifth active node; and
transfer the second set of state changes to the fifth active node based on the reception of the reset signal, wherein the reset signal further indicates an availability of the fifth active node to receive the second set of state changes, and wherein the first set of state changes and the second set of state changes are synchronously transferred to the second active node and the fifth active node, respectively, based on the reset signal.
18. The overlay system of 1,
wherein the executable graph-based model further includes a plurality of overlay nodes,
wherein the processing circuitry is further configured to identify, from the plurality of overlay nodes, a third set of overlay nodes that is associated with the first latch node,
wherein the third set of overlay nodes is configured to extend functionality of the first latch node,
wherein the processing circuitry is further configured to execute the third set of overlay nodes on the first latch node based on the reception of the reset signal,
wherein the first set of state changes is modified based on the execution of the third set of overlay nodes to obtain a modified first set of state changes, and
wherein the transfer of the first set of state changes corresponds to a transfer of the modified first set of state changes.
19. The overlay system of 1, wherein the processing circuitry is further configured to:
detect, based on the first latch node, a third set of state changes in the first active node, wherein the first latch node further couples the first active node and a sixth active node of the plurality of active nodes, and wherein the third set of state changes detected in the first active node is to be transferred to the sixth active node; and
transfer the third set of state changes to the sixth active node based on the reception of the reset signal, wherein the reset signal is further indicative of an availability of the sixth active node to receive the third set of state changes.
20. The overlay system of 1, wherein each state change in the first set of state changes corresponds to a change in a node element of the first active node.
21. The overlay system of 1, wherein the first set of state changes is periodic.
22. The overlay system of 1, wherein each node of the plurality of active nodes is one of a group consisting of a vertex node, an edge node, a role node, an overlay node, an attribute vertex node, an attribute edge node, a property vertex node, or a property edge node.
23. The overlay system of 1, wherein each active node of the plurality of active nodes and each latch node of the plurality of latch nodes is a run-time node that includes a node template and a node instance, where the node template corresponds to a predefined node structure, whereas the node instance corresponds to an implementation of the node template.
24. A method, comprising:
detecting, by processing circuitry of an overlay system, based on a first latch node of a plurality of latch nodes, a first set of state changes in a first active node of a plurality of active nodes,
   wherein an executable graph-based model is stored in a storage element of the overlay system,
   wherein the executable graph-based model includes the plurality of active nodes and the plurality of latch nodes, with each latch node coupling at least two active nodes,
   wherein the first latch node couples the first active node and a second active node of the plurality of active nodes, and
   wherein the first set of state changes detected in the first active node is to be transferred to the second active node;
receiving, by the processing circuitry, a reset signal associated with the first latch node, the reset signal indicating an availability of the second active node to receive the first set of state changes; and
transferring, by the processing circuitry, the first set of state changes to the second active node based on the reception of the reset signal.

What is claimed is:

1. An overlay system, comprising:
a storage element configured to store an executable graph-based model that includes a plurality of active nodes and a plurality of latch nodes, with each latch node coupling at least two active nodes; and
processing circuitry that is coupled to the storage element, and configured to:
detect, based on a first latch node of the plurality of latch nodes, a first set of state changes in a first active node of the plurality of active nodes, wherein the first latch node couples the first active node and a second active node of the plurality of active nodes, and wherein the first set of state changes detected in the first active node is to be transferred to the second active node;
receive a reset signal associated with the first latch node, the reset signal indicating an availability of the second active node to receive the first set of state changes; and
transfer the first set of state changes to the second active node based on the reception of the reset signal.

2. The overlay system of claim 1, wherein the processing circuitry is further configured to:
receive a first stimulus associated with the overlay system;
identify, based on the first stimulus, the first active node; and
execute an operation associated with the first stimulus based on the first active node, wherein the execution of the operation associated with the first stimulus results in the first set of state changes in the first active node.

3. The overlay system of claim 2,
wherein the executable graph-based model further includes a plurality of overlay nodes,
wherein the processing circuitry is further configured to identify, from the plurality of overlay nodes, a first set of overlay nodes that is associated with the first active node,
wherein the first set of overlay nodes is configured to extend functionality of the first active node, and
wherein the operation associated with the first stimulus is executed further based on the first set of overlay nodes.

4. The overlay system of claim 1,
wherein the first latch node has a plurality of latch roles associated therewith,
wherein an input latch role of the plurality of latch roles couples the first latch node to the first active node, and
wherein an output latch role of the plurality of latch roles couples the first latch node to the second active node.

5. The overlay system of claim 4, wherein the processing circuitry transfers the first set of state changes from the first active node to the second active node using the input latch role and the output latch role.

6. The overlay system of claim 4,
wherein the plurality of latch roles includes a trigger latch role,
wherein the first latch node is coupled to the first active node by way of the trigger latch role,
wherein the processing circuitry is further configured to monitor, using the trigger latch role, the first active node, and
wherein the processing circuitry detects the first set of state changes based on the monitoring of the first active node using the trigger latch role.

7. The overlay system of claim 6,
wherein the processing circuitry is further configured to generate, using the trigger latch role, a trigger signal based on the detection of the first set of state changes, and
wherein the transfer of the first set of state changes is further based on the trigger signal.

8. The overlay system of claim 7, wherein the trigger signal is one of a group consisting of a data signal, a timing signal, or a clock signal.

9. The overlay system of claim 7,
wherein the processing circuitry transfers the first set of state changes to the second active node based on a signal potential of the trigger signal being greater than a potential threshold;
wherein the trigger signal is one of a group consisting of an excitation signal or an inhibition signal; and
wherein the excitation signal is a positive signal and the inhibition signal is a negative signal.

10. The overlay system of claim 4,
wherein the plurality of latch roles includes a reset latch role,
wherein the first latch node is coupled to the second active node by way of the reset latch role,
wherein the processing circuitry is further configured to monitor, using the reset latch role, the second active node, and
wherein the processing circuitry receives the reset signal based on the monitoring of the second active node using the reset latch role.

11. The overlay system of claim 10, wherein the processing circuitry is further configured to:
receive a second stimulus associated with the overlay system;
identify, based on the second stimulus, the second active node; and
execute an operation associated with the second stimulus based on the second active node, wherein the reset signal is received based on the execution of the operation associated with the second stimulus.

12. The overlay system of claim 10, wherein the reset latch role is coupled to the second active node by way of a third active node of the plurality of active nodes, and wherein the processing circuitry monitors the second active node further based on the third active node.

13. The overlay system of claim 1,
wherein the processing circuitry is further configured to receive an enable signal associated with the first latch node, and
wherein the transfer of the first set of state changes is further based on the enable signal.

14. The overlay system of claim 1, wherein the processing circuitry is further configured to:
receive a third stimulus associated with the overlay system, wherein the third stimulus is received after the transfer of the first set of state changes to the second active node;
identify, based on the third stimulus, the second active node; and
execute an operation associated with the third stimulus based on the second active node with the first set of state changes.

15. The overlay system of claim 14,
wherein the executable graph-based model further includes a plurality of overlay nodes,
wherein the processing circuitry is further configured to identify, from the plurality of overlay nodes, a second set of overlay nodes that is associated with the second active node,
wherein the second set of overlay nodes is configured to extend functionality of the second active node, and
wherein the operation associated with the third stimulus is executed further based on the second set of overlay nodes.

16. The overlay system of claim 1, wherein the processing circuitry is further configured to:
detect a second set of state changes in a fourth active node of the plurality of active nodes based on a second latch node of the plurality of latch nodes, wherein the second latch node couples the fourth active node and a fifth active node of the plurality of active nodes, and wherein the second set of state changes detected in the fourth active node is to be transferred to the fifth active node; and
transfer the second set of state changes to the fifth active node based on the reception of the reset signal, wherein the reset signal further indicates an availability of the fifth active node to receive the second set of state changes, and wherein the first set of state changes and the second set of state changes are synchronously transferred to the second active node and the fifth active node, respectively, based on the reset signal.

17. The overlay system of claim 1,
wherein the executable graph-based model further includes a plurality of overlay nodes,
wherein the processing circuitry is further configured to identify, from the plurality of overlay nodes, a third set of overlay nodes that is associated with the first latch node,
wherein the third set of overlay nodes is configured to extend functionality of the first latch node,
wherein the processing circuitry is further configured to execute the third set of overlay nodes on the first latch node based on the reception of the reset signal,
wherein the first set of state changes is modified based on the execution of the third set of overlay nodes to obtain a modified first set of state changes, and
wherein the transfer of the first set of state changes corresponds to a transfer of the modified first set of state changes.

18. The overlay system of claim 1, wherein the processing circuitry is further configured to:
detect, based on the first latch node, a third set of state changes in the first active node, wherein the first latch node further couples the first active node and a sixth active node of the plurality of active nodes, and wherein the third set of state changes detected in the first active node is to be transferred to the sixth active node; and
transfer the third set of state changes to the sixth active node based on the reception of the reset signal, wherein the reset signal is further indicative of an availability of the sixth active node to receive the third set of state changes.

19. The overlay system of claim 1, wherein each active node of the plurality of active nodes and each latch node of the plurality of latch nodes is a run-time node that includes a node template and a node instance, where the node template corresponds to a predefined node structure, whereas the node instance corresponds to an implementation of the node template.

20. A method, comprising:
detecting, by processing circuitry of an overlay system, based on a first latch node of a plurality of latch nodes, a first set of state changes in a first active node of a plurality of active nodes,
wherein an executable graph-based model is stored in a storage element of the overlay system,
wherein the executable graph-based model includes the plurality of active nodes and the plurality of latch nodes, with each latch node coupling at least two active nodes,
wherein the first latch node couples the first active node and a second active node of the plurality of active nodes, and
wherein the first set of state changes detected in the first active node is to be transferred to the second active node;
receiving, by the processing circuitry, a reset signal associated with the first latch node, the reset signal indicating an availability of the second active node to receive the first set of state changes; and
transferring, by the processing circuitry, the first set of state changes to the second active node based on the reception of the reset signal.
